(19) United States
(12) Patent Application Publication
(10) Pub. No.: US 2025/0382436 A1
(43) Pub. Date: Dec. 18, 2025

(54) REDUCING FORMALDEHYDE EMISSION FROM SILICA CONTAINING POLYMER NETWORK FORMATION

(71) Applicant: Momentive Performance Materials Inc., Niskayuna, NY (US)

(72) Inventors: Lesley HWANG, Pearl River, NY (US); Chris PAPPAS, Charlotte, NC (US); Aaron RYBA, Copley, OH (US); Yogesh CHANDRASEKARAN, Bangalore (IN); Karthik Rajendran, Bangalore (IN)

(21) Appl. No.: 19/234,662

(22) Filed: Jun. 11, 2025

(30) Foreign Application Priority Data
Jun. 18, 2024 (IN) 202411046811

(51) Int. Cl. C08K 3/36; C08K 5/5445; C08K 9/06

(52) U.S. Cl. CPC C08K 3/36; C08K 5/5445; C08K 9/06

(57) ABSTRACT

A process for manufacturing rubber, (and the rubber produced) especially tire rubber including silica additives, reduces, controls, or eliminates harmful formaldehyde emissions during rubber manufacture. Preferred silica-based rubber additives can reduce formaldehyde emission during rubber manufacturing. The process and/or ingredients lead to the manufacture of exceptional rubber and tires, without such harmful emissions. Aminosilanes (preferably aminopropyltriethoxysilane) effective for reducing formaldehyde emission can be incorporated into the first rubber mixing pass. Alternatively, silanes, such as aminosilanes (preferably aminopropyltriethoxysilane) or hydrolyzable alkoxymethylamino-functional silanes (preferably Silylated Melamine Formaldehyde Resin) can be used to pretreat and/or functionalize the silica-based additives prior to rubber processing. Any formaldehyde generated from the pretreatment with an alkoxymethylamino-functional silane is more easily controlled and more safely collected to avoid exposure to workers. These methods can be combined. Aminosilanes, alkoxymethylamino-functional silanes, and alkoxymethylamino resins can be incorporated into the rubber mixing process prior to curing.

### FIELD OF THE INVENTION

The invention relates generally to polymer network-forming hydrolyzable silane compositions, processes for their preparation, and rubber compositions produced by such processes.

### BACKGROUND OF THE INVENTION

Tire manufacture and tire rubber formulating involves balancing tire performance properties. Certain additives that enhance some tire properties can adversely affect others. For example, increasing tire rubber hardness might enhance wear resistance, but reduce traction and handling. Other additives that improve tread wear can adversely impact rolling resistance. Many tire formulations include filler particles to enhance certain properties, without undesirably affecting others. Carbon black has been a prominent filler choice in tire manufacture. U.S. Pat. No. 6,608,132, incorporated herein by reference in its entirety, indicates that the particle size and structure of carbon black can affect certain key performance properties of tires, such as tread wear, rolling resistance, heat buildup and tear resistance.

While the high structure and high surface area of carbon black can enhance wear resistance and tear resistance, these characteristics can lead to highly hysteretic tire compounds. High hysteresis can adversely affect rolling resistance and as a result, negatively impact fuel usage or battery life per mile travelled. Regulatory drivers, which include Corporate Average Fuel Economy (CAFE) standards, Green House Gas (GHG) regulations, Environmental Protection Agency (EPA) regulations and European Tire Labelling regulations, have put a premium on energy savings. As a result, tire manufacturers are increasingly striving to manufacture tires with lower rolling resistances, while maintaining tire wear and traction (handling) properties. The trade-offs between wear resistance, rolling resistance and traction, when rubber compositions use conventional carbon black filler, particularly in truck, heavy vehicles and bus tire applications, has created a need for technologies that achieve an improved balance in rolling resistance, wear and traction (handling) properties. Efforts at balancing tire performance properties are described in U.S. Pat. No. 11,267,955, the entire contents of which are incorporated herein by reference.

The partial or total substitution of carbon black filler in rubber composition with silica filler or a carbon-silica dual phase filler and the optimization of the formulations through choice of rubber or mixture of rubbers and/or processing are known. The rubber compositions containing silica filler or carbon-silica dual phase filler may be chemically coupled to the rubber polymers using silane coupling agents.

Methods of manufacturing tires can involve the use of polymer network forming resins and silanes that improve some of the tradeoffs between rolling resistance and wear in natural rubber tire tread compounds. However, the process of making these tires has been found to release undesirable amounts of formaldehyde during rubber processing. The emission of excessive formaldehyde during rubber mixing, without proper safeguards, can be harmful if tire manufacture workers are exposed to it.

Accordingly, there remains a need to reduce, separate, and/or control the formaldehyde emitted during tire rubber processing, while still providing rubber compositions having an improved balance of low hysteretic properties (low rolling resistance), wear properties and traction (handling), which may be used in the fabrication of tires and other rubber goods, especially specialty tires, heavy vehicle tires, bus tires and truck tires.

### SUMMARY OF THE INVENTION

In accordance with the invention, a process is provided for controlling the formaldehyde emitted during rubber processing, leading to the manufacture of exceptional tires without the undesirable uncontrolled emission of excess formaldehyde. Rubber processing can include mixing rubbery polymers with a silica containing filler and a hydrolyzable alkoxymethylamino-functional silane that is reactive with the filler. Exposure of these silanes to the silica filler can emit undesirable amounts of formaldehyde, without the performance of at least one rubber processing formaldehyde emission mitigation step in accordance with the invention. As used herein, these mitigation steps, which can occur before the actual rubber mixing and/or during the rubber mixing, will be referred to as a formaldehyde emission reduction step. Methods in accordance with the invention are effective to reduce the amount of formaldehyde produced during the rubber mixing by over 50%. Reductions over 80% and even over 90% and 95% are also possible compared to the same rubber mixing process without the formaldehyde emission reducing steps in accordance with the invention. As noted above, these steps can occur before and/or during rubber mixing.

In a one embodiment of the invention, silanes such as hydrolyzable alkoxymethylamino-functional silanes (as used herein, AMAFS) are used to pretreat silica-containing additives prior to rubber processing (rubber mixing). Any formaldehyde generated can be collected during the silica pretreatment process, to avoid exposure to rubber processing workers. Preferred silanes include hexamethoxymethylmelamine silane (referred to herein as Silylated Melamine Formaldehyde Resin).

In another embodiment of the invention, aminosilanes effective for reducing formaldehyde emission are incorporated into the first rubber mixing pass, an unproductive pass, prior to curing. As used herein, “non-productive” combinations refer to combinations of materials that are not cured and “productive” combinations are used to result in cured compositions. Preferred aminosilanes include aminopropyltriethoxysilane (referred to herein as APTES).

In another embodiment of the invention, the alkoxymethylamino-functional silanes such as Silylated Melamine Formaldehyde Resin and/or alkoxymethylamino resins such as Melamine Formaldehyde Resin can be added to subsequent mixing passes.

In still another embodiment of the invention, (i) silanes, such as hydrolyzable alkoxymethylamino-functional silanes (e.g Silylated Melamine Formaldehyde Resin) are used to pretreat the silica-containing additives prior to rubber processing and any formaldehyde generated can be more safely collected; (ii) aminosilanes (e.g., APTES) are incorporated into the first rubber mixing pass; and (iii) alkoxymethylamino-functional silanes (e.g., Silylated Melamine Formaldehyde Resin) and/or alkoxymethylamino resins (e.g., Melamine Formaldehyde Resin) are added to the first or subsequent mixing passes; (iv) formaldehyde scavengers can also be incorporated into the rubber mixing process.

Also provided are silica-based rubber additives for reducing formaldehyde emission during rubber manufacturing. In an embodiment of the invention, the silica-based rubber additives comprise a silica-based filler, at least one AMAFS that is reactive with the silica-based filler, and optionally, an aminosilane, with the proviso that when the aminosilane is not included, the silica-based filler is pretreated with the AMAFS prior to inclusion in the rubber manufacturing process.

Also provided are uncured rubber compositions containing the hydrolyzable alkoxymethylamino-functional silane and/or hydrolyzable alkoxymethylamino resin additives, and cured rubber compounds; and tires having portions, including tread portions, made from curing said uncured rubber compounds containing the hydrolyzable alkoxymethylamino-functional silane and hydrolyzable alkoxymethylamino resin additives. Also provided are methods of forming those products that result in reduced formaldehyde emission and/or reduced formaldehyde emission during rubber processing.

Uncured rubber compositions in accordance with preferred embodiments of the invention should include effective amounts of formaldehyde reducing aminosilanes and/or silica fillers pre-treated with alkoxymethylamino-functional silanes to reduce formaldehyde emission during rubber processing. The rubber compositions can comprise (a) a rubbery polymer, such as natural rubber, synthetic rubber and a blend of polymers and copolymers, for forming a primary polymeric network; (b) a reinforcing filler that is reactive with a hydrolyzable alkoxymethylamino-functional silane; (c) a secondary network forming organic resin, especially a thermosetting network forming monomer, oligomer or polymer, for forming a secondary polymeric network; and (d) a hydrolyzable alkoxymethylamino-functional silane or hydrolyzable alkoxymethylamino resin. Rubber compositions in accordance with the invention can also optionally include (e) an active hydrogen containing organic compound capable of reacting with one or more moieties of the secondary network forming organic resin (c) and/or the hydrolyzable alkoxymethylamino-functional silane (d). Compositions in accordance with the invention can also optionally include an active hydrogen containing organic compound (e) or mixtures of organic resin (c) and an active hydrogen containing organic compound (e) thereof; and optionally (f) a sulfur-donating compound capable of reacting with the rubbery polymer (a) to form a crosslinked primary polymeric network.

As discussed above, care should be taken when combining these rubber formulation components to address formaldehyde emission during rubber processing and to implement measures to reduce formaldehyde emission or control the emission so that emitted formaldehyde can be safely contained. In one embodiment of the invention, the formaldehyde emission reducing step includes pretreating silica-containing additives with a hydrolyzable alkoxymethylamino silane prior to rubber processing. Aminosilanes are advantageously incorporated into the rubber mixing passes to reduce formaldehyde emission.

In an embodiment of the invention, the primary and secondary polymer networks can be generated in-situ. The cured rubber formulation can comprise a reinforcing silica filler (b), advantageously pre-treated with effective aminosilanes, capable of reacting with the hydrolyzable alkoxymethylamino-functional silane (d), and having the secondary polymer network coupled thereto, by means of the hydrolyzable alkoxymethylamino-functional silane additive, within the primary polymer rubber matrix. In one embodiment of the invention, the secondary polymer network is formed from the network forming organic resin (c), and the hydrolyzable alkoxymethylamino-functional silane (d) and optional active hydrogen-containing compound (e), where the secondary polymer network is not bonded directly to the rubber chains via sulfidic linkages and/or aminosilanes are advantageously incorporated into the rubber mixing passes to reduce formaldehyde emission.

Tires, passenger tires and especially tires sized, constructed and otherwise adapted to be used as heavy vehicle tires, truck tires, bus tires or specialty tires, with tread portions formulated in accordance with the invention, can be filled with silica (advantageously pre-treated to reduce formaldehyde emission during rubber processing) and carbon black, or even no carbon black. The tire tread can exhibit improvement in wear resistance when compared to similar tire tread formulations that do not contain the secondary polymer network forming components (b), (c), (d) and/or (e). The hydrolyzable alkoxymethylamino-functional silane (d) is capable of reacting with one or more moieties of the other aforementioned secondary network forming components. Preferred silanes can also be used to pre-treat the silica and reduce formaldehyde emission during rubber processing. Formaldehyde reducing aminosilanes, such as APTES can be advantageously included as well. Thus, methods in accordance with the invention can control, reduce or effectively eliminate formaldehyde emitted during these rubber processing steps.

Accordingly, it is an object of the invention to provide a process of making tires that controls, reduces or eliminates the emission of formaldehyde during rubber processing to acceptable levels and the rubber compositions and articles of manufacture formed by those methods.

One embodiment of the invention comprises (A) preparing functionalized silica additives by treating the silica with AMAFS such as Silylated Melamine Formaldehyde Resin. Such functionalized silica can be combined with AMAFS, rubbery polymers, and other rubber additives and will not lead to undesirable formaldehyde emissions during rubber mixing, leading to the safe manufacture of preferred rubber compositions.

In another embodiment of the invention, (B) silica, aminosilane liquid (e.g., APTES), polymers and other rubber manufacturing additives are combined in the first mixing pass (non-productive); and then AMAFS is added in a subsequent mixing pass, leading to the safe manufacture of preferred rubber compositions.

In another embodiment of the invention, (C) both aminosilane and AMAFS are combined with the silica, rubbery polymers, and other additives in the safe manufacture of preferred rubber compositions.

In another embodiment of the invention, (D) the silica is pretreated and functionalized with aminosilane prior to rubber mixing and then in rubber mixing, combined with AMAFS, rubbery polymers and other additives in the safe manufacture of preferred rubber compositions.

In another embodiment of the invention, (E) the silica is pre-treated and functionalized with AMAFS prior to rubber mixing, and in rubber mixing, aminosilane, rubbery polymers, and additives are combined in the safe manufacture of preferred rubber compositions.

In another embodiment of the invention, (F) silica is pre-treated and functionalized with aminosilane and silica is also pre-treated and functionalized with AMAFS prior to rubber mixing. Then in rubber mixing, the functionalized silica is combined with rubbery polymers and additives in the save manufacture of preferred rubber compositions.

Still other objects and advantages of the invention will be apparent from the specification and the scope of the invention will be indicating the claims.

### DETAILED DESCRIPTION OF THE PREFERRED EMBODIMENTS

Vehicle tires, including heavy vehicle tires, passenger tires, truck tires, bus tires or specialty tires, are typically multi-component constructions. For example, most tires include a tire casing, which acts as the body of the tire. Many tire casings are one or two body plies. The tire casing can incorporate fabric of steel, polyester, nylon or rayon cords within the casing rubber compound. A belt system can be disposed on top of (outside) the casing portion in the tire construction process. A tread slab or cap portion can be disposed on top of (outside) the belt system and/or casing. The tread portion contacts the road and is formulated to enhance the performance properties and durability of the tire. Key properties include handling, traction, rolling resistance and wear resistance. Methods of formulating rubber for the tires discussed herein are described in U.S. Pat. No. 11,267,955, the entire contents of which are incorporated herein by reference. Preferred embodiments of the invention reduce, eliminate, and/or control formaldehyde emitted with those tire forming methods.

In the specification and claims herein, the following terms and expressions are to be understood as indicated.

The singular forms “a,” “an,” and “the” include the plural, and reference to a particular numerical value includes at least that particular value, unless the context clearly dictates otherwise.

Other than in the working examples or where otherwise indicated, all numbers expressing amounts of materials, reaction conditions, time durations, quantified properties of materials, and so forth, stated in the specification and claims are to be understood as being modified in all instances by the term “about”.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

The terms, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

It will be understood that any numerical range recited herein includes all sub-ranges within that range and any combination of the various endpoints of such ranges or sub-ranges.

As used herein, integer values of stoichiometric subscripts refer to molecular species and non-integer values of stoichiometric subscripts refer to a mixture of molecular species on a molecular weight average basis, a number average basis or a mole fraction basis.

In the description that follows, all weight percentages are based on total weight percent of the organic material(s) unless stated otherwise. All ranges given herein comprise all subranges therebetween and any combination of ranges and/or subranges therebetween.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The expression “hydrocarbon group” or “hydrocarbon radical” means any hydrocarbon composed of hydrogen and carbon atoms from which one or more hydrogen atoms has been removed and is inclusive of alkyl, alkenyl, alkynyl, cycloalkyl, cycloalkenyl, cycloalkynyl, aryl, aralkyl and arenyl groups. Groups can be composed of hydrocarbon groups containing at least one heteroatom and more specifically, a hydrocarbon group containing at least one heteroatom of oxygen, nitrogen or sulfur.

The term “alkyl” means any monovalent, saturated straight chain or branched chain hydrocarbon group; the term “alkenyl” means any monovalent straight chain or branched chain hydrocarbon group containing one or more carbon-carbon double bonds where the site of attachment of the group can be either at a carbon-carbon double bond or elsewhere therein; and, the term “alkynyl” means any monovalent straight chain or branched chain hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

### Tire Rubber Formulation Components

Tire rubber formulations in accordance with the invention preferably include: Rubbery Polymers (a); Reinforcing fillers (b); Secondary polymer network forming organic resins (c); Hydrolyzable alkoxymethylamino-functional silanes (d); Active hydrogen-containing compounds (e); and Sulfur-donating compounds (f). Methods in accordance with the invention address the emission of formaldehyde during the procession of these rubber formulations. These components of the tire formulations in accordance with the invention will be discussed more fully below.

### Rubbery Polymer (a)

A “rubbery polymer”, as used herein, is an organic polymer containing at least two carbon-carbon double bonds and a backbone comprising a chain or chains of carbon atoms, or mixtures thereof. In one embodiment of the invention, rubbery polymer (a) can be at least one member selected from the group consisting of diene-based elastomers and rubbers. Rubbery polymer (a) can be any of those that are well known in the art and are described in numerous texts, of which two examples, which are incorporated herein by reference, include The Vanderbilt Rubber Handbook; R.F. Ohm, ed.; R.T. Vanderbilt Company, Inc., Norwalk, CT; 1990 and Manual For The Rubber Industry; T. Kempermann, S. Koch, J. Sumner, eds.; Bayer AG, Leverkusen, Germany; 1993.

Some representative non-limiting examples of suitable rubbery polymer (a), the rubber component of the composition, include those selected from the group consisting of natural rubber (NR), synthetic polyisoprene (IR), polybutadiene (BR), various copolymers of butadiene, the various copolymers of isoprene, solution styrene-butadiene rubber (SSBR), emulsion styrene-butadiene rubber (ESBR), ethylene-propylene terpolymers (EPDM), acrylonitrile-butadiene rubber (NBR) and combinations thereof. It is understood that natural rubber (NR) includes rubber from various natural plant sources, including but not limited to, rubber trees, dandelions, guayule, and other sources.

Suitable monomers for preparing the rubbery polymers herein can be selected from the group consisting of conjugated dienes such as the non-limiting examples of isoprene and 1,3-butadiene; and suitable vinyl aromatic compounds, such as the non-limiting examples of styrene and alpha methyl styrene; and combinations thereof. Rubbery polymers can be a sulfur curable rubber. The diene based elastomers, or rubbers, can be selected, to be at least one of cis-1,4-polyisoprene rubber, including natural rubber and synthetic polyisoprene rubber, and more specifically natural rubber, emulsion polymerization-prepared styrene/butadiene copolymer rubber, organic solution polymerization-prepared styrene/butadiene rubber, 3,4-polyisoprene rubber, isoprene/butadiene rubber, styrene/isoprene/butadiene terpolymer rubber, cis-1,4-polybutadiene, medium vinyl polybutadiene rubber (35-50 percent vinyl), high vinyl polybutadiene rubber (50-75 percent vinyl), styrene/isoprene copolymers, emulsion polymerization-prepared styrene/butadiene/acrylonitrile terpolymer rubber and butadiene/acrylonitrile copolymer rubber. Emulsion polymerization-derived styrene/butadiene rubbers (ESBR) are also contemplated as diene-based rubbers for use herein including those having a relatively conventional styrene content of 20 to 28 percent bound styrene or, for some applications, ESBR's having a medium to relatively high bound styrene content, namely, a bound styrene content of 30 to 45 percent. Emulsion polymerization-prepared styrene/butadiene/acrylonitrile terpolymer rubbers containing 2 to 40 weight percent bound acrylonitrile in the terpolymer are also contemplated as diene-based rubbers for use herein.

The rubbery polymers (a) can also be functionalized rubbers. Functionalized rubbers are rubbers modified by at least one functional group containing an atom other than carbon or hydrogen. The functional groups are typically alkoxysilyl groups, tin-containing groups, amino groups, hydroxyl groups, carboxylic acid groups, polysiloxane groups, epoxy groups, and the like, or combinations of these functional groups. The functional groups can be introduced into the rubbery polymer during the preparation of the synthetic rubber by co-polymerizing the monomers used to make the rubber with a monomer containing the functional group. Alternatively, the rubber polymers (a) can be modified with the functional group by grafting the functional group onto the already formed rubbery polymer.

The functionalized rubbery polymer can be used in combination with other non-functionalized rubbery polymers. The mixture can contain at least about 5 to about 95 parts per hundred parts rubber of at least one styrene-butadiene rubber, which is functionalized with at least one group selected from phthalocyanino, tin-containing groups, hydroxyl, epoxy, carboxylate, amino, alkoxysilyl and sulfido groups, where the styrene content is 0 to about 12 weight percent, and from about 5 to about 95 parts per hundred rubber of at least one further rubbery polymer. The functionalized rubbery polymers (rubber) generally have a glass transition temperature (Tg) according to DSC of −75 to −120° C. in the unvulcanized state.

In another embodiment of the invention, rubbery polymer (a) can be a diene polymer functionalized or modified by an alkoxysilane derivative. Silane-functionalized organic solution polymerization-prepared styrene-butadiene rubber and silane-functionalized organic solution polymerization-prepared 1,4-polybutadiene rubbers may be used. These rubber compositions are known; see, for example, U.S. Pat. No. 5,821,290 the entire contents of which are incorporated herein by reference.

In yet another embodiment of the invention, rubbery polymer (a) is a diene polymer functionalized or modified by a tin derivative. Tin-coupled copolymers of styrene and butadiene may be prepared, for example, by introducing a tin coupling agent during the styrene and 1,3-butadiene monomer copolymerization reaction in an organic solvent solution, usually at or near the end of the polymerization reaction. Such tin-coupled styrene-butadiene rubbers are well known to those skilled in the art; see, for example, U.S. Pat. No. 5,268,439, the entire contents of which are incorporated by reference herein. In practice, at least about 50 percent, and preferably from about 60 to about 85 percent, of the tin is bonded to the butadiene units of the styrene-butadiene rubbers to create a tin-dienyl bond.

Properties of natural rubber (NR) are particularly useful in the manufacture of heavy vehicle tires, bus tires and truck tires. One important reason for this is due to natural rubber's high content of cis-1, 4-polyisoprene and its ability to undergo strain-induced crystallization. In one embodiment of the invention, rubbery polymer (a) comprises natural rubber, or mixtures of natural rubber and synthetic rubbers. Preferably, when the rubbery polymer (a) is a mixture of rubbers, natural rubber should comprise at least about 10 parts of natural rubber per hundred parts rubber, preferably about 30 parts natural rubber per hundred parts rubber, more preferably at least about 50 parts natural rubber per hundred parts rubber, and still even more preferably at least about 70 parts natural rubber per hundred parts rubber.

### Reinforcing Fillers (b)

Uncured rubber compositions containing hydrolyzable alkoxymethylamino-functional silanes in accordance with the invention preferably comprise a reinforcing filler (b). Reinforcing fillers (b) should be materials whose moduli are higher than rubbery polymers (a) of the rubber composition and should be capable of absorbing stress when the cured rubber composition is strained. Reinforcing fillers (b) can be materials that are reactive with the hydrolyzable alkoxymethylamino-functional silane (d) and can include fibers, particulates and sheet-like structures. They can be composed of inorganic minerals, silicates, silica, clays, ceramics and diatomaceous earth. The reinforcing fillers that are reactive with alkoxymethylamino-functional silane (d) can be a discrete particle or group of particles in the form of aggregates or agglomerates. The alkoxymethylamino-functional silane (d) can be reactive with the surface of the filler. It can be advantageous to pre-treat the silica filler with the hydrolyzable alkoxymethylamino-functional silanes under controlled conditions, collect any emitted formaldehyde, and provide functionalized silica filler for including in the rubbery mix in accordance with the invention.

In one embodiment of the invention, silica fillers (b) are pre-treated with hydrolyzable alkoxymethylamino-functional silanes to pretreat any silica-containing fillers (b). Any formaldehyde generated can be collected during the silica pretreatment process, in order to avoid formaldehyde emission during the rubber mixing processes. Preferred silanes include Silylated Melamine-Formaldehyde Resin. Pre-treatment amounts include: (i) range of Silylated Melamine-Formaldehyde Resin to silica about 0.1-30 wt %, preferably about 5-20 wt %, most preferably about 12 wt %; range of aminosilane to silica about 0.05-10 wt %, preferably about 1-8 wt %, most preferably about 4 wt %. These weight percentages are based on the use of a 160 m²/g silica with industry standard water content for precipitated silica. Those of ordinary skill in the art will appreciate that if different types of silica having different amounts of surface water are used, this would affect the ratios. This would also inherently account for variable water content as water content tends to correlate with surface area.

Particulate precipitated silica can be useful as reinforcing filler that is reactive with the alkoxymethylamino-functional silane (d), particularly when the silica has reactive surface silanols. For various reasons, the silicas may be provided in a hydrated form or be converted to a hydrated form by reaction with water. It can be important to control any formaldehyde released by a reaction with this water, as discussed more fully herein, such as pre-treatment with effective silanes or incorporating effective silanes into the rubber mixture. The reinforcing filler (b) can be used in the amount of from about 1 to about 150 parts reinforcing filler (b) per 100 parts of the rubbery polymer (a), preferably from about 25 to about 90 parts reinforcing filler (b) per 100 parts of the rubbery polymer (a) and more preferably from about 40 to about 80 parts reinforcing filler (b) per 100 parts of the rubber polymer (a). As discussed herein, controlling any water on the surface of silica fillers during tire formation, pre-treatment and/or silane additive inclusion can be effective to reduce formaldehyde emission during rubber processing.

Representative non-limiting examples of reinforcing fillers (b) that are reactive with alkoxymethylamino-functional silane (d) include at least one metalloid oxide or metal oxide such as pyrogenic silica, precipitated silica, titanium dioxide, aluminosilicate, alumina and siliceous materials including clays and talc and combinations thereof.

In specific embodiment herein, reinforcing filler (b) which is reactive with the alkoxymethylamino-functional silane (d) is a silica used alone or in combination with one or more other fillers, e.g., organic and/or inorganic fillers that do not react with alkoxymethylamino-functional silane (d). A representative non-limiting example is the combination of silica and carbon black, such as for reinforcing fillers for various rubber products, including the non-limiting example of treads for tires. Alumina can be used either alone or in combination with silica. The term “alumina” herein refers to aluminum oxide, or Al₂O₃. Use of alumina in rubber compositions is known; see, for example, U.S. Pat. No. 5,116,886 and EP 631 982, the entire contents of both of which are incorporated by reference herein.

Reinforcing fillers (b) that are reactive with the alkoxymethylamino-functional silane (d) can be used as a carrier for the alkoxymethylamino-functional silane (d). Other fillers that can be used as carriers are non-reactive with alkoxymethylamino-functional silane (d). The non-reactive nature of the fillers is demonstrated by the ability of alkoxymethylamino-functional silane (d) to be extracted at greater than 50 percent of the loaded silane using an organic solvent. The extraction procedure is described in U.S. Pat. No. 6,005,027, the entire contents of which are incorporated herein by reference. Representative of non-reactive carriers include, but are not limited to, porous organic polymers and carbon black. The amount of alkoxymethylamino-functional silane (d) that can be loaded on the carrier is preferably from about 0.1 to about 70 percent and more preferably from about 10 to about 50 percent, based on the total weight of the carrier and alkoxymethylamino-functional silane (d).

In one non-limiting embodiment of the invention, the other fillers that may be mixed with reinforcing filler that is reactive with the alkoxymethylamino-functional silane (d) can be essentially inert to the alkoxymethylamino-functional silane (d) with which they are admixed as is the case with carbon black or organic polymers. In another embodiment, at least two reinforcing fillers that are reactive with alkoxymethylamino-functional silane (d) can be mixed together and can be reactive therewith. Reinforcing fillers that possess metalloid hydroxyl surface functionality, such as silicas and other siliceous particulates which possess surface silanol functionality, can be used in combination with reinforcing fillers containing metal hydroxyl surface functionality, such as alumina and other siliceous fillers.

In one embodiment of the invention, precipitated silica is utilized as reinforcing filler (b) that is reactive with alkoxymethylamino-functional silane (d). In a preferred embodiment of the invention, the silica fillers can be characterized by having a Brunauer, Emmett and Teller (BET) surface area, as measured using nitrogen gas, in the range of from about 40 to about 600 m²/g, preferably in the range of from about 50 to about 300 m²/g and more preferably in the range of from about 100 to about 220 m²/g. The BET method of measuring surface area, described in the Journal of the American Chemical Society, Volume 60, page 304 (1930), is the method used herein. In yet another preferred embodiment, the silica is typically characterized by having a dibutylphthalate (DBP) absorption value in a range of from about 100 to about 350, preferably from about 150 to about 300 and more preferably from about 200 to about 250. In other embodiments, reinforcing filler (b) that is reactive with the alkoxymethylamino-functional silane (d) is alumina and aluminosilicate fillers, and possess a CTAB surface area in the range of from about 80 to about 220 m²/g. CTAB surface area is the external surface area as determined by cetyl trimethylammonium bromide with a pH of about 9; the method for its measurement is described in ASTM D 3849.

Mercury porosity surface area is the specific surface area determined by mercury porosimetry. In this technique, mercury is penetrated into the pores of the sample after a thermal treatment to remove volatiles. In a more specific embodiment, set-up conditions use a 100 milligram sample, remove volatiles over 2 hours at 105° C. and ambient atmospheric pressure and employ a measuring range of from ambient to 2000 bars pressure. Such evaluations can be performed according to the method described in Winslow, et al. in ASTM bulletin, p. 39 (1959) or according to DIN 66133; for such an evaluation, a CARLO-ERBA Porosimeter 2000 can be used. Particularly useful reinforcing fillers (b) that are reactive with the alkoxymethylamino-functional silane (d) include silica, which has an average mercury porosity specific surface area in a range of from about 100 to about 300 m²/g, preferably from about 150 to about 275 m²/g and more preferably from about 200 to about 250 m²/g.

Suitable pore size distribution for reinforcing filler (b) that are reactive with the alkoxymethylamino-functional silane (d) include the non-limiting examples of silica, alumina and aluminosilicate, according to such mercury porosity evaluation, is considered herein to be five percent or less of its pores having a diameter of less than 10 nm; from about 60 to about 90 percent of its pores having a diameter of from 10 to 100 nm; from about 10 to about 30 percent of its pores having a diameter of from 100 to 1,000 nm; and, from about 5 to about 20 percent of its pores having a diameter of greater than 1,000 nm. These reinforcing fillers (b) can normally be expected to have an average ultimate particle size in the range of from about 0.005 to about 0.075 μm, preferably of from about 0.01 to about 0.05 □m as determined by electron microscopy, although the particles can be smaller or larger in average size. Various commercially available silicas can be used herein such as those available from PPG Industries under the HI-SIL trademark, in particular, HI-SIL 210, and 243; silicas available from Solvay, e.g., ZEOSIL 1165MP; silicas available from Evonik, e.g., VN2 and VN3, etc., and silicas available from Huber, e.g., HUBERSIL 8745.

In one embodiment of the invention, the filler can comprise a reinforcing filler (b) that is reactive with the alkoxymethylamino-functional silane (d) in the amount of from about 15 to about 95 weight percent precipitated silica, alumina and/or aluminosilicate, preferably silica and, correspondingly, from about 5 to about 85 weight percent carbon black having a CTAB value in a range of from about 80 to about 150, more preferably, the filler can comprise from about 60 to about 95 weight percent of said silica, alumina and/or aluminosilicate, preferably silica and, correspondingly, from about 40 to about 50 weight percent of carbon black. The precipitated silica, alumina and/or aluminosilicate filler and carbon black can be pre-blended or blended together during the manufacture of the vulcanized rubber.

Tire tread portions are conventionally formulated with carbon black filler. Carbon black provides tread portions with exceptional wear resistance, which leads to high mileage, long lasting tires. When silica is used as filler, it can form a silica-silica network during the tire manufacturing process. This network can affect tire properties, such as rolling resistance. Adding conventional silanes to tire formulations can reduce rolling resistance by limiting silica-silica network formation and immobilizing polymer chains on the silica surface. Furthermore, severely restricting chain mobility could affect the ability of natural rubber to undergo strain-induced crystallization and compromise wear resistance and tear resistance.

### Secondary Polymer Network Forming Organic Resins (c)

It has been determined that the shortcomings of using conventional silanes in silica filled rubber formulations, particularly wear resistance, can be addressed by what is believed to be coupling the reinforcing filler (b) that is reactive with an alkoxymethylamino-functional silane (d), to a reinforcing “secondary polymeric network”. This secondary polymer network is preferably formed in-situ within the rubber matrix and not bonded directly to the rubber chains of the primary polymer network via sulfidic linkages. The secondary polymeric network can be formed from secondary polymer network forming organic resins (c) or can be formed from secondary polymer network forming organic resins (c) and active hydrogen-containing compounds (e). These secondary polymer networks are preferably thermosetting resins that react with the alkoxymethylamino-functional silane (d). A more detailed discussion of these organic resins can be found in U.S. Pat. No. 11,267,955.

Rolling resistance can be lowered by hydrophobating the silica. Increasing the effective filler volume promotes wear resistance and tear resistance. Furthermore, the secondary polymeric network can increase reinforcement and stiffness of the resulting tread under static and dynamic deformations.

This secondary polymer network polymerization is believed to grow from the reinforcing filler surface, especially silica surface, which has reacted with the alkoxymethylamino-functional silane (d). These alkoxymethylamino-functional silanes (d) can function as initiators or co-initiators during the rubber mixing and/or curing process. The resulting secondary polymer network may create additional points of physical and chemical chain entanglements for the rubber phase. These entanglements, along with the resulting secondary polymeric network and the silica, are believed to create a hierarchical structure whose modulus gradient is useful for load transfer from the rubbery polymer chains to the silica during static and dynamic deformation, thereby enhancing tear and wear resistance and reducing abrasion. The secondary polymer network polymerization from the filler surface can lead to the creation of a network structure on the filler surface and increases the effective filler volume. This network structure and effective filler volume result in additional reinforcement, which is also helpful for improved wear resistance.

Such polymeric networks are formed from secondary polymer network organic resins (c) and active hydrogen-containing compounds (e). These secondary polymer network forming organic resins (c) include polyisocyanates, polyisocyanurates, epoxy resins, amino resins and polyurethanes. Secondary polymer network forming active hydrogen-containing compounds (e) include, but are not limited to, polyols, polyamines, polyureas, polyamides, hydroxyl-containing polyacrylates, hydroxyl containing polymethacrylates, polycarboxylates, hydroxyl substituted alkyl, aryl, or alkylene groups, amine substituted alkyl, aryl, alkylene groups, thiol substituted alkyl, aryl or alkylene groups.

### Hydrolyzable Alkoxymethylamino-Functional Silane (d)

Hydrolyzable alkoxymethylamino-functional silanes (d), in accordance with the present invention, are organic compounds that contain at least one hydrolyzable silyl group and at least one, preferably at least two, alkoxymethylamino-functional groups in which alkoxymethylamino-functional groups are bonded to the rest of the organic compound to form a N—C covalent bond, where the carbon atom is sp² hybridized. The sp²-hybridized carbon means that the carbon atom is bonded to three other atoms to form a planar structure, and also contains a p-orbital that is perpendicular to the plane form from the carbon atom and the three other atoms bonded to it. The sp²-hybridized carbon includes for example —C(═C)—, —C(═O)—, —C(═N)— or C(═S)—, where the two hyphens represent chemical bonds to other atoms, and the underline carbon atom is the carbon atoms which is a sp²-hybridized carbon atom. A more detailed discussion of these silanes can be found in U.S. Pat. No. 11,267,955. A preferred hydrolyzable alkoxymethylamino-functional silanes (d), in accordance with the invention, is Silylated Melamine Formaldehyde Resin.

In one embodiment of the present invention, the alkoxymethylamino-functional group has the chemical Formula (I):

R¹OCH₂N— (I)

where R¹ is independently hydrogen, an alkyl group having from 1 to 10 carbon atoms, a cycloalkyl group having from 3 to 10 carbon atoms, alkenyl group having from 2 to 10 carbon atoms, an aryl group having from 6 to 12 carbon atoms or an aralkyl group having from 7 to 12 carbon atoms, more preferably an alkyl group having from 1 to 3 carbon atoms and even more preferably methyl or ethyl, and the nitrogen atom is bonded to a sp²-hybridized carbon atom.

Hydrolyzable alkoxymethylamino-functional silanes in accordance with the present invention can also contain at least one hydrolyzable silyl group. In one embodiment of the invention, the silyl groups have the chemical Formula (II):

(R²O)ₐR³₃₋ₐSiR⁴XN— (II)

where each R² is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, more preferably an alkyl group having from 1 to 3 carbon atoms and even more preferably ethyl; each R³ is independently an alkyl group having from 1 to 3 carbon atoms or phenyl; R⁴ is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, more preferably an alkylene group having from 1 to 6 carbon atoms, and even more preferably, a propylene; X is —SCH₂—, R¹OC(═O)NCH₂—, —NR₁C(═O)N(R¹) CH₂—, R¹₂N(C═O)NCH₂—, —NR₁ (C═O)OCH₂—, —OCH₂—, —NR₁CH₂— or —OCH₂CH(OH)CH₂OCH₂— group, more preferably a —SCH₂— or —NR₁CH₂— group, and even more preferably-SCH₂—, where the methylene carbon atom of the group is bonded to the nitrogen atom, or —NH(C═O)—, —OCH₂CH(OH)CH₂— or a chemical bond which forms the bond between the R⁴ group and the nitrogen atom shown in Formula (II); the subscript a is an integer where a is equal to 1, 2 or 3, and more preferably 3, with the proviso that the nitrogen atom shown in Formula (II) is bonded to a sp²-hybridized carbon atom.

In another embodiment of the invention, the hydrolyzable alkoxymethylamino-functional silanes (d) in accordance with the present invention are derived from amino resins. The amino containing compounds useful in preparing the hydrolyzable alkoxymethylamino-functional silanes include, but are not limited to, 2,4,6-triamino-1,3,5-triazine, benzoguanamine, urea, glycoluril and copolymers of (meth)acrylamide. Amino resins are made by reacting the amino containing compounds with formaldehyde and subsequently with alcohols.

In still another embodiment of the invention, the hydrolyzable alkoxymethylamino-functional silanes (d) in accordance with the present invention have the chemical structures selected from the group consisting of structures having the general Formulae (III)-(V) or stereoisomers thereof:

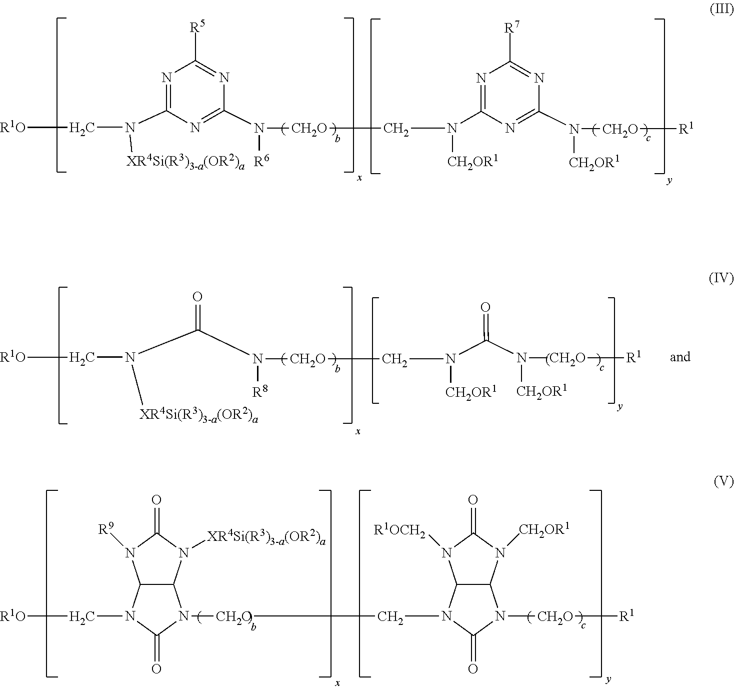

wherein
each R¹ is independently hydrogen, an alkyl group having from 1 to 10 carbon atoms, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably an alkyl group having from 1 to 3 carbon atoms and more preferably methyl;
each R² is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably an alkyl group having from 1 to 3 carbon atoms and more preferably ethyl;
each R³ is independently an alkyl group having from 1 to 3 carbon atoms or phenyl;
each R⁴ is independently an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, preferably an alkylene group having from 1 to 6 carbon atoms, and more preferably, a propylene;
each R⁵ and R⁷ is independently phenyl, —N(CH₂OR¹) 2, —N(CH₂OR¹)(XR⁴Si(R³)₃₋ₐ(OR²)ₐ), —N(XR⁴Si(R³)₃₋ₐ(OR²)ₐ)₂,

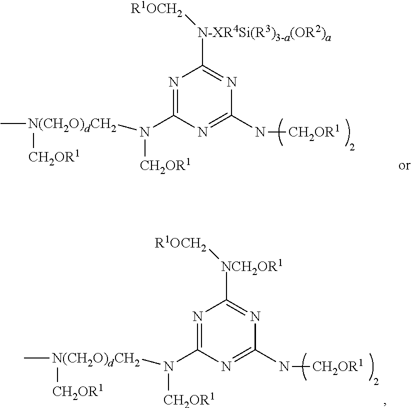

preferably-N(CH₂OR¹)₂ or —N(CH₂OR¹)(XR⁴Si(R³)₃₋ₐ(OR²)ₐ);
each R⁶, R⁸ and R⁹ is independently hydrogen, —CH₂OR¹ or —XR⁴Si(R³)₃₋ₐ(OR²) a, more specifically-CH₂OR¹;
each X is independently-SCH₂—, R¹OC(═O)NCH₂—, —NR₁C(═O)N(R¹) CH₂—, R¹₂N(C═O)NCH₂—, —NR₁ (C═O)OCH₂—, —OCH₂—, —NR₁CH₂—, or —OCH₂CH(OH)CH₂OCH₂— group, more preferably a —SCH₂— or —NR₁CH₂— group, and even more preferably-SCH₂—, where the methylene carbon atom of the group is bonded to the nitrogen atom, or X is independently —NH(C═O)—, —OCH₂CH(OH)CH₂— or a chemical bond which forms the bond between the R⁴ group and the nitrogen atom, with the proviso that the nitrogen atom is bonded to a sp²-hybridized carbon atom; the subscripts a, b, c, d, x and y are independently integers where a is 1, 2 or 3, preferably 3; b is 0 or 1, more preferably 1; c is 0 or 1, preferably 1; x is from 1 to 20, preferably 1, 2 or 3; and y is from 0 to 20, preferably 0.

Representative and non-limiting examples of the hydrolyzable alkoxymethylamino-functional silane (d) include 1-(5-trimethoxysilyl-2-thiapentyl)-1,3,3-tris-methoxymethylurea, 1,3-bis-(1-(5-trimethoxysilyl-2-thiapentyl)-1,3-bis-methoxymethylurea, 3,3-bis-(3-dimethoxysilyl-2-thiapropyl)-1,1-bis-methoxymethylurea, 1-(5-triethoxysilyl-2-thiapentyl)-1,3,3-tetra-ethoxymethylurea, 1-(5-triethoxysilyl-2-aza-2-methyl-pentyl)-1,3,3-tris-ethoxymethylurea, 1,3-bis-(7-triethoxysilyl-2,4-diaza-3-oxo-heptyl)-1,3-bis-ethoxymethylurea, 3,3-bis-(1-(5-triethoxysilyl-2-thiapentyl)-1,1-bis-ethoxymethylurea, 1-(5-triethoxysilyl-2-thiapentyl)-1,3,3-tris-propoxymethylurea, 1-(5-triethoxysilyl-2-thiapentyl)-1,3,3-tris-propoxymethylurea, 1,3-bis-(5-tripropoxysilyl-2-thiapentyl)-1,3-bis-propoxymethylurea, 3,3-bis-(5-tripropoxysilyl-2-thiapentyl)-1,1-bis-propoxymethylurea, 1,3-bis-(5-tripropoxysilyl-2-thiapentyl)-1,3,3-tetra-butoxymethylurea, 1-(5-triphenoxysilyl-2-thiapentyl)-1,3,3-tetra-phenoxymethylurea, N-[1-(5-triethoxysilyl-2-thiapentyl)-1,3-tris-ethoxymethylureidomethyl]-1,3,3-tetra-ethoxymethylurea, N,N′-bis-[(1-(5-triethoxysilyl-2-thiapentyl)-1,3-bis-ethoxymethylureidomethyl]-1,3-bis-ethoxymethylurea, N,N′-bis-[1-(5-triethoxysilyl-2-thiapentyl)-1,3-bis-ethoxymethylureido-methoxymethyl]-1,3-bis-ethoxymethylurea, N-(5-triethoxysilyl-2-thiapentyl)-N,N′,N′,N″,N″-pentakis-methoxymethyl-[1,3,5]triazine-2,4,6-triamine, N, N″-bis-(5-triethoxysilyl-2-thiapentyl)-N,N′,N′,N″-tetrakis-methoxymethyl-[1,3,5]triazine-2,4,6-triamine, N′, N″-(5-triethoxysilyl-2-thiapentyl)-N,N,N′,N″-tetrakis-methoxymethyl-[1,3,5]triazine-2,4,6-triamine, N-(5-triethoxysilyl-2-aza-2-methyl-pentyl)-N,N′,N′,N″,N″-pentakis-ethoxymethyl-[1,3,5]triazine-2,4,6-triamine, N″-(7-triethoxysilyl-2,4-diaza-3-oxo-heptyl)-N,N,N′,N′,N″-pentakis-ethoxymethyl-[1,3,5]triazine-2,4,6-triamine, N′,N″-(7-triethoxysilyl-2,4-diaza-3-oxo-heptyl)-N,N,N′,N″-tetrakis-ethoxymethyl-[1,3,5]triazine-2,4,6-triamine, N-(5-triethoxysilyl-2-aza-2-methyl-pentyl)-N,N′,N′,N″,N″-pentakis-propoxymethyl-[1,3,5]triazine-2,4,6-triamine, N-(5-triethoxysilyl-2-aza-2-methyl-pentyl)-N,N′,N′,N″,N″-pentakis-phenoxymethyl-[1,3,5]triazine-2,4,6-triamine, 1-(5-triethoxysilyl-2-thia-pentyl)-3,4,6-tris-methoxymethyl-tetrahydro-imidazo[4,5-d]imidazole-2,5-dione, 1-(5-triethoxysilyl-2-aza-2-methyl-pentyl)-3,4,6-tris-ethoxymethyl-tetrahydro-imidazo[4,5-d]imidazole-2,5-dione, 3,6-bis-(5-triethoxysilyl-2-thia-pentyl)-1,4-bis-ethoxymethyl-tetrahydro-imidazo[4,5-d]imidazole-2,5-dione, 6-(5-triethoxysilyl-2-aza-2-methyl-pentyl)-1,3,4,-tris-methoxymethyl-tetrahydro-imidazo[4,5-d]imidazole-2,5-dione and 6-(5-triethoxysilyl-2-thia-pentyl)-1,3,4, -tris-phenoxymethyl-tetrahydro-imidazo[4,5-d]imidazole-2,5-dione, preferably 1-(5-trimethoxysilyl-2-thiapentyl)-1,3,3-tris-methoxymethylurea, N-[1-(5-triethoxysilyl-2-thiapentyl)-1,3-tris-ethoxymethylureidomethyl]-1,3,3-tetra-ethoxymethylurea, N-(5-triethoxysilyl-2-thiapentyl)-N,N′,N′,N″,N″-pentakis-methoxymethyl-[1,3,5]triazine-2,4,6-triamine, N, N″-bis-(5-triethoxysilyl-2-thiapentyl)-N,N′,N′,N″-tetrakis-methoxymethyl-[1,3,5]triazine-2,4,6-triamine, N′, N″-(5-triethoxysilyl-2-thiapentyl)-N,N,N′,N″-tetrakis-methoxymethyl-[1,3,5]triazine-2,4,6-triamine, N-(5-triethoxysilyl-2-aza-2-methyl-pentyl)-N,N′,N′,N″,N″-pentakis-ethoxymethyl-[1,3,5]triazine-2,4,6-triamine and 1-(5-triethoxysilyl-2-thia-pentyl)-3,4,6-tris-methoxymethyl-tetrahydro-imidazo[4,5-d]imidazole-2,5-dione.

In one embodiment of the invention, the hydrolyzable alkoxymethylamino-functional silane is formed by combining a silane containing a functional group with an amino resin. The amino resin may be a component in the secondary polymer network forming organic resin (c). The hydrolyzable alkoxymethylamino-functional silane (d) can be formed prior to addition of the hydrolyzable alkoxymethylamino-functional silane (d) to the rubber composition. The hydrolyzable alkoxymethylamino-functional silane (d) can be used in the amounts of from 0.1 to 30 parts hydrolyzable alkoxymethylamino-functional silane (d) per 100 parts of the rubbery polymer (a), more specifically, from 0.5 to 15 parts hydrolyzable alkoxymethylamino-functional silane (d) per 100 parts rubbery polymer (a) and even more specifically from 1 to 10 parts hydrolyzable alkoxymethylamino-functional silane (d) per 100 parts of the rubbery polymer (a). Alternatively, the silane containing a functional group can be added to a rubber composition containing the amino resin (c) which may be used to form the secondary polymer network, to generate the hydrolyzable alkoxymethylamino-functional silane (d) in situ. When the hydrolyzable alkoxymethylamino-functional silane (d) is generated in situ, the silane containing a functional group can be used in the amounts of amount of 0.1 to 30 parts silane containing a functional group per 100 parts of rubbery polymer (a), more specifically from 0.2 to 15 parts silane containing a functional group per 100 parts of rubbery polymer (a) and even more specifically from 0.3 to 10 parts silane containing a functional group per 100 parts of rubbery polymer (a) and the organic resin can be use in the amount of 0.2 to 35 parts organic resin (c) per 100 parts of rubbery polymer (a), more specifically from 0.4 to 15 parts organic resin (c) per 100 parts of rubbery polymer (a) and even more specifically from 1 to 10 parts organic resin (c) per 100 parts of rubbery polymer (a).

In an embodiment of the invention, the hydrolyzable alkoxymethylamino-functional silane (d) is prepared by the following process:
(i) contacting an amino resin having the structure of general Formula (VII), (VIII) or (IX), where R¹² is —CH₂OR¹⁰, with a silane containing a functional group having the general Formula (X):

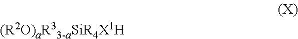

wherein
each R² is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably an alkyl group having from 1 to 3 carbon atoms and more preferably ethyl;
each R³ is independently an alkyl group having from 1 to 3 carbon atoms or phenyl;
R⁴ is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, preferably an alkylene group having from 1 to 6 carbon atoms, and more preferably, a propylene;
X¹ is —O—, —S—, —NR¹³—, —NR¹³C(═O)NR¹³—, —where R¹³ is hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably hydrogen or an alkyl group having from 1 to 3 carbon atoms and more preferably a hydrogen;
a is an integer equal to 0, 1 or 2, or contacting an amino resin having the structure of general Formula (VII), (VIII) or (IX), where at least one R¹² is hydrogen or —CH₂OH, with a silane containing a functional group having the general Formula (XI):

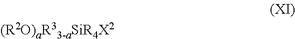

wherein
each R² is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably an alkyl group having from 1 to 3 carbon atoms and more preferably ethyl;
each R³ is independently an alkyl group having from 1 to 3 carbon atoms or phenyl;
R⁴ is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, preferably an alkylene group having from 1 to 6 carbon atoms, and more preferably, a propylene;
X² is —Cl, —Br,

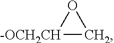

N═C═O, —NR¹³C(═O)NR¹³₂ or —NR¹³C(═O)OR¹³ where R¹³ is hydrogen, an alkyl group having from 1 to 10 carbon atoms and optionally at least one oxygen atom, a cycloalkyl group having from 3 to 10 carbon atoms, alkenyl group having from 2 to 10 carbon atoms, an aryl group having from 6 to 12 carbon atoms or an aralkyl group having from 7 to 12 carbon atoms, preferably hydrogen or an alkyl group having from 1 to 3 carbon atoms and more preferably a hydrogen;
a is an integer equal to 0, 1 or 2;
   (ii) reacting the amino resin of step (i) with the silane containing a functional group of step (i); and, optionally
   (iii) removing the byproducts selected from the group R¹⁰OH, R¹³OH, R¹³²NH, HCl or HBr from the reaction mixture if the byproduct is formed in the reaction.

The molar ratio of the —X¹H group to the R¹⁰OCH₂N— group or the —X² to R¹₂ group is from about 0.1 to 0.8, preferably, from 0.2 to 0.5. The reaction product, the hydrolyzable alkoxymethylamino-functional silane (d), has at least one (R²O)ₐR³₃₋ₐSiR₄X— group and at least two R¹⁰OCH₂N— groups or has at least one (R²O)ₐR³₃₋ₐSiR₄X— group and at least one (R¹⁰OCH₂)₂N— group.

Representative an non-limiting examples of silane contain a functional group of Formula (X) include 3-mercaptopropyltrimethoxysilane, 3-mercaptopropyltriethoxysilane, 3-mercaptopropyltripropoxysilane, 3-mercaptopropyldimethoxyethoxysilane, 3-mercaptopropylmethyldiethoxysilane, 3-mercaptopropyldimethylethoxysilane, mercaptomethyltriethoxysilane, 4-mercapto-3,3-dimethylbutyltriethoxysilane, 3-mercaptopropylethoxy-[1,3,2]dioxasilinane, 3-mercaptopropyl-(3-hydroxy-2-methylpropoxy)-5-methyl-[1,3,2]dioxasilinane, 6-mercaptohexyltriethoxysilane, 3-aminopropyltriethoxysilane, N-ethyl-3-aminopropyltriethoxysilane, N-methyl-3-aminopropyltriethoxysilane, N-ethyl-3,3-dimethyl-4-aminobutyltriethoxysilane, n-phenyl-3-aminopropyltriethoxysilane, 3-ureidopropyltriethoxysilane, 3-ureidopropyltrimethoxysilane and mixtures thereof.

Representative an non-limiting examples of silane contain a functional group of Formula (XI) include N-(3-triethoxypropyl)-O-methylcarbamate, N-(3-triethoxysilylpropyl)-O-ethylcarbamate, 3-ureidopropyltriethoxysilane, 3-ureidopropyltrimethoxysilane, isocyanatomethyltriethoxysilane, isocyanatomethylmethyldiethoxysilane, 3-isocyanatopropyltrimethoxysilane, 3-isocyanatopropyltriethoxysilane, chloromethyltriethoxysilane, 3-chloropropyltriethoxysilane, 3-bromopropyltriethoxysilane, 3-glycidoxypropyltriethoxysilane, 3-glycidoxypropyltrimethoxysilane, 3-glycidoxypropylmethyldiethoxysilane, 3-glycidoxypropylmethyldimethoxysilane and the like.

The reaction can be catalyzed. Typical catalysts are Brønsted-Lowry acids, as for example, sulfur acid, phosphoric acid, p-toluene sulfonic acid and hydrochloric acid, acid catalysts supported on solid polymeric resin, such solid sulfonated polystyrene and solid phosphonated polystyrene resin, or Lewis acids, as for example, dibutyltin oxide, dibutyl tin dilaurate, tetra alkyl titanates, zirconium or titanium complexes, and the like. The catalyst can optionally be removed from the hydrolyzable alkoxymethylamino-functional silane (d) by filtration of the acid catalysts supported on the solid polymeric resin, neutralization of Brønsted-Lowry acids with bases, absorption of the acid catalyst on an absorbent and followed by filtration of the reaction mixture or removal of the acid catalyst using an ion exchange resin, followed by filtration. The reaction can be carried out in the presence or absence of a solvent, such as hydrocarbon solvents, ether solvents, chlorinated solvents and the like.

The reactions can be carried out at sub-atmospheric, atmospheric or super-atmospheric pressure ranging from 0.01 kilogram-force/centimeter² to 5 kilogram-force/centimeter², more preferably from 1 kilogram-force/centimeter² to 1 kilogram-force/centimeter² and temperatures, and temperatures ranging from about 15° C. to 150° C., more preferably, from 30° C. to 100° C.

In another embodiment of the invention, the hydrolyzable alkoxymethylamino-functional silane (d) is prepared by the process comprising (i) contacting an amino resin having the structure of general Formula (VII), (VIII) or (IX), where R¹² is —CH₂OR¹⁰, with a silane containing a functional group having the general Formula (X), (ii) reacting an amino resin with the silane containing a functional group of step (i) and optionally (iii) removing the alcohol, R¹⁰OH. The reaction can be carried out in a reactor in the absence of the rubbery polymer (a) or in situ in a rubber composition comprising a rubber polymer (a) and optionally a reinforcing filler (b), where the silane containing a functional group has formed silanols and said silanols have reacted with reinforcing filler (b) to form covalent chemical bonds with the filler.

Preferably the silane containing a functional group can be a mercapto-functionalized silane, an ureido-functionalized silane, an amino-functionalized silane, a carbamato-functionalized silane, an epoxy-functionalized silane, an isocyanato-functionalized silanes or a blocked isocyanato-functionalized silane.

The mercaptofunctionalized silane used to prepare the hydrolyzable alkoxymethylamino-functional has the general Formula (VI):

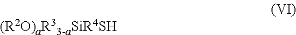

wherein
each R² is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, preferably an alkyl group having from 1 to 3 carbon atoms and more preferably ethyl;
each R³ is independently an alkyl group having from 1 to 3 carbon atoms or phenyl;
R⁴ is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, preferably an alkylene group having from 1 to 6 carbon atoms, and more preferably, a propylene, and a is an integer equal to 0, 1 or 2.

### Preparation of Hydrolyzable Alkoxymethylamino-Functional Silanes (d)

A process is for the synthesis of an alkoxymethylamino-functional silane (d) (Silylated Melamine Formaldehyde Resin) in accordance with the invention. The mole ratio of silane containing a functional group to amino resin is about 1:1 is described below: Hexamethoxymethylmelamine (815 grams, available from Ineos as Resimene 3520) and 3-mercaptopropyltriethoxysilane (497.9 grams, available from Momentive Performance Materials under the tradename Silquest® A-1891 silane) were charged into a 2-liter round bottom flask equipped with a magnetic stirrer, a short-path distillation head, a heating mantle, and a temperature controller. The contents were heated to 40° C. until the components became miscible. Sulfuric acid (0.3 grams) was then added to the reaction flask. The contents were heated from 40° C. to 100° C. under 18 mmHg of initial vacuum. The vacuum was lowered to 9 mmHg while collecting methanol. A total of 103 grams of low boiling compounds and 1198.7 grams of Silylated Melamine Formaldehyde Resin product were recovered. The product was analyzed by GC, 13C NMR, LC/MS and GPC. The structure of Silylated Melamine Formaldehyde Resin was determined to include a mixture of structures, where the average structure was:

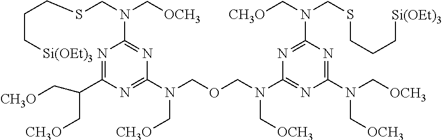

The components of the mixture included:

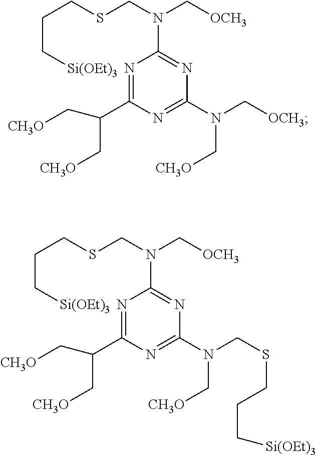

and stereoisomers of the two triethoxysilyl reaction products, and

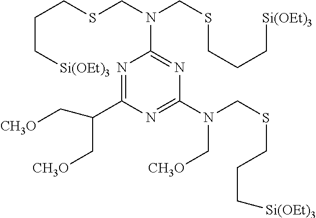

and stereoisomers of the three triethoxysilyl reaction products.

### Active Hydrogen-Containing Compound (e)

The active hydrogen-containing compounds (e) are organic compounds containing at least two functional groups having a hydrogen atom bonded to a heteroatom of oxygen or nitrogen. The functional groups of the active hydrogen-containing compounds (e) includes hydroxyl, amido, ureido and amino. The active hydrogen-containing compound (e) can be used in the amounts of 0.1 to 30 parts active hydrogen-containing compounds (e) per 100 parts of rubbery polymer (a), more specifically from 0.2 to 15 parts active hydrogen-containing compounds (e) per 100 parts of rubbery polymer (a) and even more specifically from 0.3 to 10 parts active hydrogen-containing compounds (e) per 100 parts of rubbery polymer (a)

In one embodiment of the invention, the active hydrogen-containing compound (e) has the general Formula (XII):

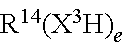

wherein R¹⁴ is a polyvalent organic group having from 1 to 100 carbon atom, preferably a polyvalent hydrocarbon group containing 1 to 50 carbon atoms or a polyvalent hydrocarbon containing 1 to 100 carbon atoms, more preferably 1 to 50 carbon atoms, and containing at least one heteroatom of oxygen or nitrogen; X³ is —NH—, —NR¹⁵—, —C(O)NH—, —C(═O)NR¹⁵—, —NHC(═O)NH—, —NH(═O)NR¹⁵—, —S—, —C(═O)O— or —O—, preferably-NH—, —NR¹⁵— or —O—, wherein R¹⁵ is independently an alkyl group having from 1 to 10 carbon atoms, a cycloalkyl group having from 3 to 10 carbon atoms, an alkenyl group having from 2 to 10 carbon atoms, an aryl group having from 6 to 12 carbon atoms, an aralkyl group having from 7 to 12 carbon atoms or hydrogen, more preferably an alkyl group having from 1 to 3 carbon atoms or hydrogen and even more preferably hydrogen, methyl or ethyl; and e is an integer of from 2 to 15, more preferably 2 to 10 and even more preferably 2, 3, 4 or 5. X³—H is an active hydrogen functional group, including amino functional groups, amido functional groups, carbamato functional groups, ureido functional groups, hydroxyl functional groups or mercapto functional groups.

Representative and non-limiting examples of the active hydrogen-containing compound (e) include aliphatic diols, triols or polyols, such as ethylene glycol, propylene glycol, 1,3-butanediol, diethylene glycol, triethylene glycol, polyethylene glycol having a molecular weight of up to about 2000 grams/mole, preferably from about 190 to about 2000 grams/mole, dipropylene glycol, tripropylene glycol polypropylene glycol having a molecular weight of from about 250 to about 2500 grams/mole, glycerol, trimethylolmethane, trimethylolethane, trimethylolpropane, pentaerythritol, glycerol monostearate and sorbitan monostearate; aromatic diols, triol or polyols, such as catechol, resorcinol, phloroglucinol, hydroquinone, phenol-formaldehyde resins, which include novolac resins in which formaldehyde to phenol molar ratio of less than one and resole resins in which the formaldehyde to phenol molar ratio is greater than or equal to one, penacolite resins, terephthaldehyde adducts, 2,2-bis(4-hydroxyphenyl) butane, 2,2-bis(4-hydroxyphenyl) propane, 1,1-bis(4-hydroxyphenyl) ethane, bis(4-hydroxyphenyl) methane and resorcinol-formaldehyde resins; polyamines, such as ethylene diamine, diethylene triamine, triethylene tetraamine, bis-(2-aminoethyl) ether and 2-aminoethyl heptanamide; and urea formaldehyde resins, preferably as catechol, resorcinol, hydroquinone, 2,2-bis(4-hydroxyphenyl) butane, novolac resins, resole resins and resorcinol-formaldehyde resins.

The active hydrogen-containing compound (e) can be commercially purchased, as for example, GP® 161G66, GP® 4864 triazone, GP® 445D05, GP® 48634, GP® 5018, GP® 5236 and GP® 7648 available from Georgia-Pacific Chemicals, penacolite resins P-19-s, B-20-s and r-2170 available from OXY INDSPEC Chemical Corporation, and Cellobond™ Resin J6030L and Cellobond™ J60021X01 available from Hexion.

### Sulfur-Donating Compound (f)

The sulfur-donating compound (f) can be used to crosslink the rubbery polymer to form a crosslinked primary network. Without wishing to be bound by a particular theory, the sulfur-donating compound (f) is believed to donate sulfur atoms under curing conditions. The sulfur-donating compound (f) generally has more than two sulfur atoms bonded together to form a chain of sulfur atoms. Polysulfides and elemental sulfur are sulfur-donating compounds (f), preferably sulfur, S₈.

Vulcanization can be conducted in the presence of sulfur-donating compound (f), often referred to as a vulcanizing agent. It reacts with the rubbery polymer (a) containing carbon-carbon double bonds to form a crosslinked, or cured, rubber. Some non-limiting examples of suitable sulfur vulcanizing agents include, e.g., elemental sulfur (free sulfur) or sulfur-donating compound such as the non-limiting examples of amino disulfide, polymeric polysulfide or sulfur-olefin adducts. These and other known and conventional vulcanizing agents are added in the usual amounts during a mixing step referred to as a productive mixing step in the process for preparing rubber compositions.

The sulfur-donating compounds are generally used at about 0.1 to about 5 phr, more preferably from about 1 to about 3 phr and even more preferably from about 1.5 to about 2.5 phr.

### Other Components of the Rubber Compositions

The rubber compositions in accordance with the invention also advantageously include aminosilanes effective for reducing formaldehyde emission. Preferred aminosilanes include aminopropyltriethoxysilane (APTES). In another embodiment of the invention, silanes such as hydrolyzable alkoxymethylamino-functional silanes, preferably Silylated-Melamine Formaldehyde Resin, are used to pretreat silica-containing additives prior to rubber processing.

In another embodiment of the invention, the rubber compositions may include primary non-silane amines with boiling points above 160° C. to help mitigate the formaldehyde emission. Examples of preferred primary non-silane amines include: Octadecyl amine, Tetraethylenetretramine, Octylamine, tris(2-aminoethyl)amine, and combinations thereof. These amines may be present in amounts from about 0.1% to about 15% by weight of the total filler loading, preferably about 2% to about 8% by weight of the total filler loading.

The rubber compositions can be compounded with other commonly used additive materials such as, e.g., retarders and accelerators, processing additives such as oils, resins such as tackifying resins, plasticizers, pigments, fatty acid, zinc oxide, waxes, antioxidants and antiozonants, peptizing agents, and the like. Depending on the intended use of the rubber compositions, these and/or other rubber additives are used in conventional amounts.

Vulcanization accelerators can also be used if desired. Non-limiting examples of vulcanization accelerators include benzothiazole, alkyl thiuram disulfide, guanidine derivatives and thiocarbamates. Other examples of such accelerators include, but are not limited to, mercapto benzothiazole, tetramethyl thiuram disulfide, tetrabenzyl thiuram disulfide, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methylpiperazine), dithiobis(N-beta-hydroxy ethyl piperazine) and dithiobis(dibenzyl amine). In another embodiment, other additional sulfur donors include, e.g., thiuram and morpholine derivatives. In a more specific embodiment, representative of such donors include, but are not limited to, dimorpholine disulfide, dimorpholine tetrasulfide, tetramethyl thiuram tetrasulfide, benzothiazyl-2,N-dithiomorpholide, thioplasts, dipentamethylenethiuram hexasulfide and disulfidecaprolactam.

Accelerators may be used to control the time and/or temperature required for vulcanization and to improve the properties of the vulcanizate. In one embodiment of the invention, a single accelerator system can be used, i.e., a primary accelerator. In another embodiment, conventionally and preferably, a primary accelerator(s) is used in total amounts ranging from about 0.5 to about 4 phr, and preferably from about 0.8 to about 2.0 phr. In a preferred embodiment, combinations of a primary and a secondary accelerator can be used with the secondary accelerator being used in smaller amounts, e.g., from about 0.05 to about 3 phr in order to activate and to improve the properties of the vulcanizate. In yet another embodiment, delayed action accelerators can also be used. In still another embodiment, vulcanization retarders can also be used. Suitable types of accelerators are those such as the non-limiting examples of amines, disulfides, guanidines, thioureas, thiazoles, thiurams, sulfenamides, dithiocarbamates, xanthates and combinations thereof. In a preferred embodiment, the primary accelerator is a sulfenamide. In another embodiment, if a second accelerator is used, the secondary accelerator can be a guanidine, dithiocarbamate or thiuram compound, such as for example tetrabenzyl thiuram disulfide used at levels from about 0.1 to about 0.3 phr, more preferably about 0.2 phr.

Optional tackifier resins can be used at levels of from about 0.5 to about 10 phr and preferably from about 1 to about 5 phr. In a preferred embodiment, the amounts of processing aids range from about 1 to about 50 phr. Suitable processing aids can include, as non-limiting examples, aromatic, naphthenic and/or paraffinic processing oils and combinations thereof. In yet another embodiment, preferred amounts of antioxidants are from about 1 to about 5 phr. Representative antioxidants include, as non-limiting examples, diphenyl-p-phenylenediamine and others, e.g., those disclosed in the Vanderbilt Rubber Handbook (1978), pages 344-346, which is incorporated by reference herein. In yet another embodiment, preferred amounts of antiozonants range from about 1 to about 5 phr. Preferred amounts of optional fatty acids, which can include the non-limiting example of stearic acid, range from about 0.5 to about 3 phr. Preferred amounts of zinc oxide range from about 2 to about 5 phr. Preferred amounts of waxes, e.g., microcrystalline wax, range from about 1 to about 5 phr. Preferred amounts of peptizers range from about 0.1 to about 1 phr. Suitable peptizers include, as non-limiting examples, pentachlorothiophenol, dibenzamidodiphenyl disulfide and combinations thereof.

In one embodiment of the invention, the uncured rubber compositions contain the hydrolyzable alkoxymethylamino-functional silane (d), and the rubber composition preferably comprises at least one rubbery polymer (a) used to form a primary network, at least one reinforcing filler (b) that is capable of reacting with the hydrolyzable alkoxymethylamino-functional silane (d); at least one secondary polymer network forming organic resin (c); at least one hydrolyzable alkoxymethylamino-functional silane (d) that can be reacted with the reinforcing filler (b), and optionally, at least one active hydrogen containing organic compound (e) or at least one active hydrogen containing organic compound (e) and at least one sulfur-donating compound (f), especially sulfur (S₈).

The rubbery polymer component (a) comprises one or more rubber components in which the rubber components add up to about 100 phr (parts per hundred rubber). In one embodiment of the invention, natural rubber should be about 50 to 100 phr of the primary polymer blend portion of the rubber composition, preferably about 75 to 100 phr.

The reinforcing filler (b) can comprise about 1 to about 150 phr of the rubber composition, preferably from about 15 to 90 phr, more preferably from about 20 to 55 phr. In one embodiment of the invention, the reinforcing filler (b) is silica, preferably precipitated silica.

The hydrolyzable alkoxymethylamino-functional silane (d) itself and/or the materials for forming the secondary network (network forming organic resins and active hydrogen-containing compounds) can comprise from about 6 to 50% of reinforcing filler weight portion of the formulation, preferably from about 8 to 25% of the reinforcing filler weight, more preferably about 12 to 25% of the reinforcing filler (b) weight in the formulation.

Thus, rubber compositions in accordance with the invention can comprise:
(a) a rubbery polymer or blend of polymers;
(b) at least one reinforcing filler that is reactive with the hydrolyzable alkoxymethylamino-functional silane (d), pretreated as described above to reduce formaldehyde emission during rubber processing;
(c) at least one organic resin;
(d) at least one hydrolyzable alkoxymethylamino-functional silane;
(e) at least one formaldehyde reducing aminosilane;
(f) at least one active hydrogen containing organic compound; and
(g) at least one a sulfur-donating compound.

In an embodiment of the invention, the rubber composition comprises alkoxymethylamino-functional silane (d) in an amount of from about 0.2 to about 20 weight percent based on the total weight of rubber composition, the rubbery component (a) in an amount of from about 25 to about 95 weight percent based on the total weight of the rubber composition, the reinforcing filler (b) that is reactive with the alkoxymethylamino-functional silane (d) in an amount of from about 2 to about 70 weight percent based on the total weight of rubber composition, the organic resin (c) in the amount of from about 0.2 to about 25 weight percent based on the total weight of the rubber composition, the active hydrogen-containing compound (e) in the amount of from about 0.2 to about 25 weight percent based on the total weight of the rubber composition and the amount of the sulfur-donating compound (f) in an amount of from about 0.2 to about 5 weight percent based on the total weight of the rubber composition.

In still another embodiment, the rubber composition comprising a combination of:
(i) a primary polymeric network comprising (a) a rubbery polymer or blend of polymers and (b) at least one sulfur-donating compound; and
(ii) a secondary polymeric network comprising the reaction product of (b) at least one reinforcing filler, (c) at least one organic resin, (d) at least one hydrolyzable alkoxymethylamino-functional silane (e) at least one active hydrogen containing organic compound.

In the primary polymeric network, the rubbery polymer (a) is selected from the group consisting of natural rubber (NR), synthetic polyisoprene (IR), polybutadiene (BR), various copolymers of butadiene, the copolymers of isoprene, solution styrene-butadiene rubber (SSBR), emulsion styrene-butadiene rubber (ESBR), ethylene-propylene terpolymers (EPDM), acrylonitrile-butadiene rubber (NBR), and functionalized rubbers that are modified by at least one alkoxysilyl group, tin-containing group, amino group, hydroxyl group, carboxylic acid group, polysiloxane group, epoxy group or phthalocyanimo group. In particular, the rubber polymer (a) comprises natural rubber or a mixture of natural rubber and butadiene rubber. In the primary polymeric network, the at least one sulfur donating compound (f) is sulfur.

In the secondary polymeric network, the reinforcing filler (b) before reaction with the reacting with the alkoxymethylamino-functional silane (d) can be fibers, particulates or sheet-like structures comprising metalloid oxides or metal oxides having surface hydroxyl groups that are capable of reacting with the alkoxymethylamino-functional silane (d). In particular, the reinforcing filler (b) before reaction with the with the alkoxymethylamino-functional silane (d) can be silicates, clays, ceramics, diatomaceous earth, pyrogenic silica, precipitated silica, titanium dioxide, aluminosilicate, alumina, talc and mixtures thereof, and more particularly, precipitated silica.

In the secondary polymeric network, before the organic polymer (c) has reacted with the other reactants used in the formation of the secondary polymeric network, the organic polymer (c) can be polyisocyanates, polyisocyanurates, epoxy resins, amino resins and polyurethanes.

In the secondary polymeric network, the active hydrogen-containing organic compound (e) before reaction with the other reactants used in the formation of the secondary polymeric network has the structure of Formula (XII):

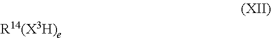

wherein R¹⁴ is a polyvalent organic group having from 1 to 100 carbon atoms or a polyvalent hydrocarbon containing 1 to 100 carbon atoms containing at least one heteroatom of oxygen or nitrogen; X³ is —NH—, —NR¹⁵—, —C(O)NH—, —C(═O)NR¹⁵—, —NHC(═O)NH—, —NH(═O)NR¹⁵—, —S—, —C(═O)O— or —O—, where R¹⁵ is independently an alkyl group having from 1 to 10 carbon atoms, a cycloalkyl group having from 3 to 10 carbon atoms, an alkenyl group having from 2 to 10 carbon atoms, an aryl group having from 6 to 12 carbon atoms, an aralkyl group having from 7 to 12 carbon atoms or hydrogen.

In one embodiment, R¹⁴ contains at least one ether functional group, amino functional group, ester functional group, ketone functional group, aldehyde functional groups, amido functional groups, carbamato functional group or ureido functional group.

In one embodiment of the invention, the amounts of components (b), (c), (d) and (e) before reaction to form the secondary polymeric network are alkoxymethylamino-functional silane (d) in the amount of from about 0.2 to about 20 weight percent based on the total weight of rubber composition, the reinforcing filler (b) that is reactive with the alkoxymethylamino-functional silane (d) in the amount of from about 2 to about 70 weight percent based on the total weight of rubber composition, the organic resin (c) in the amount of from about 0.2 to about 25 weight percent based on the total weight of the rubber composition and the active hydrogen-containing compound (e) in the amount of from about 0.2 to about 25 weight percent based on the total weight of the rubber composition.

In the cured rubber composition, the primary polymeric network is cured to form a crosslinked rubber polymer or crosslinked blend of polymers by subjecting the rubber composition to an elevated temperature for a time sufficient to react the rubber polymer or blend or rubber polymers (a) with the at least one sulfur-donating compound (f).

### Process for Providing a Rubber Composition

In one embodiment of the invention, the process for providing the rubber compositions described herein involves the mixing of components (a), (b), (c), (d), (e), (f) and (g), as disclosed above, in effective amounts. In one embodiment of a process in accordance with the invention, an effective amount of alkoxymethylamino-functional silane (d) can range from about 0.2 to about 20, preferably from about 0.5 to about 15 and more preferably from about 2 to about 10, weight percent based on the total weight of rubber composition. An effective amount of rubbery component (a) can range from about 25 to about 95, preferably from about 50 to about 90 and more preferably from about 60 to about 80, weight percent based on the total weight of the rubber composition. An effective amount of the reinforcing filler that is reactive with the alkoxymethylamino-functional silane (d) can range from about 2 to about 70, preferably from about 5 to about 55 and more preferably from about 20 to about 50, weight percent based on the total weight of rubber composition. An effective amount of organic resin (c) can range from about 0.2 to about 25 weight percent, preferably from about 2 to about 15 weight percent and more preferably from about 5 to about 10, weight percent based on the total weight of the rubber composition. An effective amount of the active hydrogen-containing compound (e) can range from about 0.2 to about 25 weight percent, preferably from about 2 to about 15 weight percent and more preferably from about 5 to about 10, weight percent based on the total weight of the rubber composition. An effective amount of the sulfur-donating compound (f) can range from about 0.2 to about 5, preferably from about 0.5 to about 2.5 and more preferably from about 1 to about 2, weight percent based on the total weight of the rubber composition.

In another embodiment of the invention, the process for preparing a rubber composition can optionally comprise curing the rubber composition, before, during and/or after molding the rubber composition. A vulcanized rubber composition should contain a sufficient amount of the secondary polymer network to contribute to a higher modulus and better wear. The combined weight of the reinforcing filler that is reactive with the alkoxymethylamino-functional silane (d) can be as low as 5 and can range preferably from about 10 to about 150 parts per hundred parts of rubbery polymer (a) (phr) and more preferably ranged from about 25 to about 85 phr, and even more preferably from about 50 to about 70 phr.

In one embodiment of the invention, the hydrolyzable alkoxymethylamino-functional silane (d) can be premixed, or prereacted, with particles, aggregates and/or agglomerates of the reinforcing filler (b) or added to the rubber mix during the processing or mixing of the rubbery polymer (a) and reinforcing filler (b). In another embodiment, the alkoxymethylamino-functional silane (d) and reinforcing filler (b) are added separately to the process mixture containing rubbery polymer (a) component. Reinforcing filler (b) and hydrolyzable alkoxymethylamino-functional silane (d) can be considered to couple or react in situ to form a reinforcing filler in which the alkoxymethylamino-functional silane (d) is chemically bonded to the filler.

### Preparation of Rubber

In one embodiment of the invention, the process for preparing rubber compositions in accordance with the invention comprise multiple steps. In a non-productive (non-curing) step (i), components (a), (b) and (d) are mixed under reactive-mechanical-working conditions. Formaldehyde reducing aminosilanes such as APTES can be incorporated, and silica additives can be pretreated with hydrolyzable alkoxymethylamino-functional silanes, such as Silylated Melamine-Formaldehyde Resin. As used herein, the expression “reactive-mechanical-working conditions” shall be understood to mean the conditions of elevated temperature, residence time and shear prevailing within a mechanical-working apparatus, such as an extruder, intermeshing mixer, or tangential mixer, such conditions being sufficient to bring about one or more of the following:
a) the reactive process of hydrolysis of alkoxymethylamino-functional silane (d) with water, which is present on the reinforcing filler (b), to form alkoxymethylamino-functional silanols;
b) the reactive process of these silanols with reinforcing filler (b) to form covalent chemical bonds with the filler;
c) the breakdown of reinforcing filler (b) agglomerates into smaller aggregates and/or individual filler particles;
d) the dispersion into the rubbery polymer (a) the reinforcing filler (b) covalently bonded to hydrolyzed and subsequently condensed alkoxymethylamino-functional silane
e) the incorporation of formaldehyde reducing aminosilanes such as APTES; and
f) pretreated of silica filler with hydrolyzable alkoxymethylamino-functional silanes, such as Silylated Melamine-Formaldehyde Resin.

In a non-productive step (ii), the organic resin (c) and/or the active hydrogen-containing components (e) are added to the mixture of step (i). In the non-productive step (ii), components (a), (b), (c), (d) and (e) are mixed under reactive-mechanical-working conditions, where the conditions of elevated temperature, residence time and shear prevailing within a mechanical-working apparatus, such as an extruder, intermeshing mixer, or tangential mixer, such conditions being sufficient to bring about one or more of the following:
g) the dispersion into the mixture of the rubbery polymer (a), reinforcing filler (b) covalently bonded to hydrolyzed and subsequently condensed alkoxymethylamino-functional silane of step (i) the organic resin (c) and active hydrogen-containing compound (e);
h) reaction of the reinforcing filler (b) covalently bonded to hydrolyzed and subsequently condensed alkoxymethylamino-functional silane with the organic resin (c) or the active hydrogen-containing compound (e) or the organic resin (c) and the active hydrogen-containing compound (e); and optionally
i) reaction of the organic resin (c) with the active hydrogen-containing compound (e) if present to form the secondary network dispersed within the primary network and provide for uncured rubber composition.
   If either the organic resin (c) or the active hydrogen-containing components (d) are not added in step (ii), then the missing ingredient can be added in a second non-productive mixing step (ii).

In a productive step (iii), the sulfur-donating compound (f) is added to the mixture of step (ii) and this composition is cured.

In any of steps (i), (ii) or (iii), other components can be added to the rubber composition. Representative and non-limiting examples of other components include activators, processing aids, accelerators, waxes, oils, anti-ozonants and anti-oxidants,

The rubber composition is typically mixed in a mixing apparatus under high shear conditions where it autogenously heats up as a result of the mixing, primarily due to shear and associated friction occurring within the rubber mixture.

In a preferred embodiment of the invention, the mixture of the desired amounts of rubbery polymer (a), reinforcing filler (b) and hydrolyzable alkoxymethylamino-functional silane (d) of step (i) is substantially homogeneously blended under reactive-mechanical-working conditions in mixing step (i) carried out on a continuous or non-continuous basis. Non-continuous mixing can be employed where a build-up of excessive heat might occur and the rubber composition may need to be cooled. Cooling of the rubber will avoid or minimize thermal decomposition of rubbery polymer component(s) or other components in the rubber composition. Preferably, mixing step (i) is conducted at temperatures from 100° C. to 200° C. and more preferably from 140° C. to 180° C.

In step (iii), at least one sulfur-donating compound (f) along with other vulcanization accelerators, can be mixed with the rubber composition from step (ii). Mixing should be accomplished under non-reactive-mechanical-working conditions. As used herein, the expression “non-reactive-mechanical-working” conditions shall be understood to mean the conditions of sub-ambient, ambient or slightly elevated temperature, residence time and shear prevailing within a mechanical-working apparatus, such as an extruder, intermeshing mixer, tangential mixer, or roll mill, such conditions being sufficient to bring about dispersion of the sulfur-donating compound (f), e.g. vulcanizing agent, and vulcanization accelerators into the rubber composition of step (ii) without resulting in any appreciable vulcanization of the rubber composition. Low temperatures and low shear are advantageously employed in step (iii).

In productive step (iii), residence time can vary considerably and is generally chosen to complete the dispersion of the vulcanizing agent. Residence times in most cases can range from 0.5 to 30 minutes and preferably from 5 to 20 minutes.

The temperature employed in step (iii) can range from 5° C. to 150° C., preferably from 30° C. to 120° C. and more preferably from 50° C. to 110° C. These temperatures are lower than those utilized for reactive-mechanical-working conditions in order to prevent or inhibit premature curing of the sulfur-curable rubber, sometimes referred to as scorching of the rubber composition, which might take place at higher temperatures.

The rubber composition may be allowed to cool, e.g., during or after step (iii) or between step (i) and step (ii) or between step (ii) and step (iii), to a temperature of 50° C. or less.

In another embodiment of the invention, when it is desired to mold and to cure the rubber composition, the rubber composition is placed in the desired mold and heated to at least about 130 □C and up to about 200 □C for a time of from 1 to 60 minutes to bring about the vulcanization of the rubber.

Rubber compositions preferred for forming tire tread portions in accordance with preferred embodiments of the invention comprise (a) a rubbery primary polymer or blend of polymers, (b) reinforcing silica filler particles, (c) an organic resin capable of forming a secondary polymer network, which can be generated in-situ, (d) a hydrolyzable alkoxymethylamino-functional silane which can react with the reinforcing filler (b) and/or an active hydrogen-containing compound (e) in which components (b), (c), (d) and (e) contribute to the aforementioned secondary network.

The rubber composition herein can be used for various purposes. In one embodiment of the invention, there is provided an article of which at least one component is the herein described cured rubber composition. In another embodiment herein, there is provided a tire at least one component of which, e.g., the tread, is the herein described cured rubber composition. In yet another preferred embodiment, for example, the rubber composition can be used for the manufacture of such articles as shoe soles, hoses, seals, cable jackets, gaskets and other industrial goods. Such articles can be built, shaped, molded and cured by various known and conventional methods as is readily apparent to those skilled in the art. In particular, the compositions and methods in accordance with the invention are particularly well suited for the manufacture of tires, in particular, truck or bus tires.

As noted above, it has been determined that preparation of rubber compounds as discussed above can lead to the unacceptable emission of formaldehyde. It is understood that the reaction of hexamethoxymethylmelamine (HMMM) resins with water can produce formaldehyde. This reaction can be catalyzed by acid. Silylated Melamine-Formaldehyde Resin has the same functional groups that can undergo this chemistry. The silica additives that are used with tire production in accordance with the invention may have water on the silica surface. This can vary by grade and environmental exposure. However, it is believed to be about 6-9% water by weight. It may be that during mixing, the water on the silica surface reacts with the AMAFSs such as HMMM based silanes and yield formaldehyde, which can be released into the air during rubber processing.

Methods in accordance with preferred embodiments of the invention can reduce or eliminate harmful formaldehyde emissions. Method 1 uses formaldehyde reducing aminosilanes as an ingredient in the silica-filled rubber formulation. Aminosilanes effective at reducing formaldehyde emission, in accordance with the invention preferably have the following general Formula (AS):

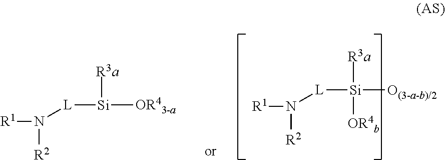

wherein:
L=C1-C10 straight or branched alkylene group or C5-C14 cycloalkylene group;
R¹=H, C1-C10 straight or branched alkyl or alkylene group which may contain hetero atoms such as N or O, C5-C14 cycloalkyl group which may contain hetero atoms such as N or O, C5-C18 aryl or aralkyl group which may contain hetero atoms such as N or O;
R²=R¹ or -L-Si(R₃) (OR₄)₃-a;
R³=C1-C10 straight or branched alkyl or alkylene group, C6-C18 aryl or aralkyl group;
R⁴=H, C1-C10 straight or branched alkyl or alkylene group, C6-C18 aryl or aralkyl group;

$$a = 0 , 1 , 2 ;$$

$$b = 0 , 1 , 2 ;$$

$$and$$

$$a + b \leq 2$$

In certain preferred embodiments of the invention, primary aminosilanes can be more effective at formaldehyde reduction than secondary or tertiary aminosilanes. Aminopropyltriethoxysilane (APTES) is a particularly effective aminosilane at reducing formaldehyde emission. Additional aminosilanes effective for reducing formaldehyde formation in accordance with the invention include:
Gamma-aminopropyltrimethoxysilane, H₂NCH₂CH₂CH₂Si(OMe) 3;
N-beta-(Aminoethyl)-gamma-aminopropyltrimethoxysilane, H₂NCH₂CH₂NHCH₂CH₂CH₂Si(OMe)₃;
N-(2-aminoethyl)-N′-[3-(trimethoxysilyl) propyl]-1,2-Ethanediamine, H₂NCH₂CH₂NHCH₂CH₂NHCH₂CH₂CH₂Si(OMe)₃;
gamma-aminopropyltriethoxysilane, H₂NCH₂CH₂CH₂Si(OEt)₃;
Aminopropylsilsesquioxanes, (H₂NCH₂CH₂CH₂SiO_{1.5})ₙ;
bis-(gamma-triethoxysilylpropyl)amine, (EtO) 3SiCH₂CH₂CH₂NHCH₂CH₂CH₂Si(OEt)₃;
bis-(gamma-trimethoxysilylpropyl)amine, (MeO) 3SiCH₂CH₂CH₂NHCH₂CH₂CH₂Si(OMe)₃;
N-beta-(Aminoethyl)-gamma-aminopropylmethyldimethoxysilane, H₂NCH₂CH₂NHCH₂CH₂CH₂SiMe (OMe)₂;

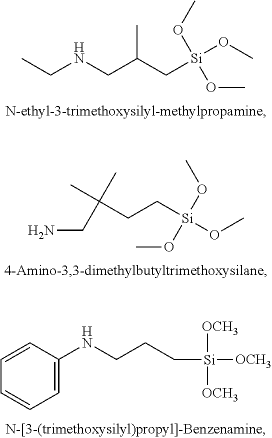 [SMILES: CCNCC(C)C[Si](OC)(OC)OC ; CO[Si](CCC(C)(C)CN)(OC)OC ; CO[Si](CCCNc1ccccc1)(OC)OC]

Method 1A includes formaldehyde reducing aminosilanes, e.g., APTES, in the first mixing pass, followed by the addition of alkoxymethylamino-functional silanes (AMAFSs), such as Silylated Melamine-Formaldehyde Resin, in the second (or subsequent) mixing pass.

Method 1B includes both formaldehyde reducing aminosilanes and alkoxymethylamino-functional silanes in the first mixing pass.

In another preferred embodiment of the invention, the reaction of the silica moisture with the alkoxymethylamino-functional silane (e.g., Silylated Melamine-Formaldehyde Resin) can be reduced or eliminated by first evaporating off the moisture with the heat of the first mixing pass. Then, in a subsequent mixing pass, the alkoxymethylamino-functional silane is added to the rubber compound after the bulk of the water is removed. Processing temperatures in the first mixing pass can reach 160° C., which facilitates water evaporation.

In other preferred embodiments of the invention, it may not be practical to remove the silane completely from the first mixing pass formulation because of potential material handling difficulties with the rubber/silica mixture. Therefore, in these embodiments of the invention, an aminosilane (e.g., APTES) can be included to address handling issues.

Method 2 uses silica pretreated with the alkoxymethylamino-functional silane Silylated Melamine-Formaldehyde Resin). It can be advantageous in Method 2 to let the reaction of the water on the silica and the alkoxymethylamino-functional silane (e.g., Silylated Melamine-Formaldehyde Resin) form formaldehyde before the rubber compound is mixed in a silica-pretreatment process, where the silica and silane are combined and reacted early in the process. Thus, the formaldehyde is formed, removed and collected in a controlled and safe manner prior to worker exposure. Then, the silane treated silica can be used in the first mixing pass to form the polymer network and provide the beneficial properties of the silane with greatly reduced or without formaldehyde exposure to the worker.

### Combination of Method 1 and 2:

Both Methods 1 and 2 can be used alone or in combination. In practical usage, the tire compounder could employ the following methods:
Using both hydrolyzable alkoxymethylamino-functional silanes (e.g., Silylated Melamine Formaldehyde Resin) pretreated silica in addition to liquid aminosilane (e.g., APTES);
Using aminosilane (e.g., APTES) pretreated silica in addition to Silylated Melamine Formaldehyde Resin;
Silica pretreatment with both APTES and AMAFS (e.g., Silylated Melamine Formaldehyde Resin)
Adding aminosilanes (e.g., APTES) to the first mixing pass without Silylated Melamine Formaldehyde Resin; and
Adding aminosilanes (e.g., APTES) in an early mixing step and adding hydrolyzable alkoxymethylamino-functional silanes (e.g Silylated Melamine Formaldehyde Resin) in a later mixing step.

Formaldehyde scavengers, such as sodium sulfite, can advantageously be added to all of the above usage combinations to further reduce formaldehyde emissions.

Aspects and attributes of preferred embodiments of the invention will be described with reference to the following examples, which are being presented for purposes of illustration only, and should not be construed as limiting.

### Example 1

### Demonstration of Method 1, VOC Collection to Determine Formaldehyde Emissions

A rubber composition is prepared as follows, by mixing the ingredients in a Banbury® laboratory mixer. The mixing of the rubber is performed in four steps.

The mixer was set at a temperature of 140° F. +/−10° F. (55° C.) and maintained at this temperature using cooling water. The ingredients are listed below in Table 1′. In the first mixing step, to be referred to as Masterbatch 1 (MB1) or Non-Productive 1 (NP1), the polymers were added to the mixer and ram down mixed for 40 seconds. Half of the silica, Silylated Melamine Formaldehyde Resin and APTES were added to the mixer and ram down mixed for 50 seconds. The rest of the silica and the other ingredients of MB1, except for the carbon black and process oil, were added and mixed to a temperature of 260° F. (127° C.). The carbon black and process oil were added to the mixer and mixed to a temperature of 280° F. (138° C.). The mixer was swept to ensure all the materials were added to the mixing chamber. The ingredients were mixed to a temperature of 311° F. (155° C.) at a speed of less than 95 rpm and held at temperature for 150 seconds. The total mixing time of MB1 was approximately 480 seconds. Alternatively, only an MB1 mixing pass could have been utilized for testing formaldehyde emissions. Where a single masterbatch was mixed, ingredients may be pulled up from later mixing steps to create a representative compound for measuring formaldehyde emissions.

The material was discharged from the mixing chamber and milled on a two-roll mill set at a temperature of approximately 140° F. (60° C.). The rubber was allowed to wrap around one cylinder and form a rolling bank of rubber at the nip between the two cylinders. A crosscut of the rubber during milling while wrapped, starting with a 1-inch ribbon, from left to right with 1 inch per revolution was made as the rubber was removed from the mill. The milling steps were repeated five times and then allowed to cool to ambient temperature. The milled rubber was designated as MB1, which is a non-productive mixing step.

In the second mixing step, referred to as Masterbatch 2 (MB2) or Non-Productive 2 (NP2), the rubber composition of MB1 was recharged into the mixer. In another embodiment of the invention, additional ingredients may be added into the mixer with MB1 such as Silylated Melamine-Formaldehyde Resin, silica, etc. The mixer's speed was 80 rpm, the mixer temperature was 140° F. +/−10° F. (60° C.). The temperature was increased to 302° F. (150° C.) and held at temperature for 150 seconds. The total mixing time was approximately 480 seconds. In other embodiments of the invention, some of the ingredients may be split and/or delayed to MB2 from MB1. This may be done to affect ingredient dispersion, incorporation, or to optimize rubber shear during mixing.

The material was discharged from the mixing chamber and milled on a two-roll mill set at a temperature of approximately 140° F. (60° C.). The rubber was allowed to wrap around one cylinder and form a rolling bank of rubber at the nip between the two cylinders. A crosscut was made of the rubber, starting with a 1 inch ribbon, from left to right with 1 inch per revolution made as the rubber was removed from the mill. The milling steps were repeated five times and then allowed to cool to ambient temperature. The milled rubber was designated as MB2, which is a non-productive mixing step.

In the third mixing step, referred to as Masterbatch 3 (MB3) or Non-Productive 3 (NP3), the rubber composition of MB2 is recharged into the mixer. In another aspect of the invention, additional ingredients are added into the mixer with MB2 such as resorcinol or resorcinol resins such as Penacolite® Resin. The mixer's speed was 80 rpm, the mixer temperature was 140° F. +/−10° F. (60° C.). The temperature was increased to 280° F. (138° C.) and held at temperature for 150 seconds. The total mixing time was approximately 480 seconds.

The material was discharged from the mixing chamber and milled on a two-roll mill set at a temperature of approximately 140° F. (60° C.). The rubber was allowed to wrap around one cylinder and form a rolling bank of rubber at the nip between the two cylinders. A crosscut of the rubber, starting with a 1 inch ribbon, from left to right with 1 inch per revolution was made as the rubber was removed from the mill. The milling steps were repeated five times and then allowed to cool to ambient temperature. The milled rubber was designated as MB3, which is the third non-productive mixing step.

In the fourth mixing step, referred to as Masterbatch 4 or Non-Productive 4 (NP4), or Final Mix (FM), the mixer temperature was set at 100° F. +/−10° F. (38° C.). MB3 rubber and the vulcanization chemicals were charged into the mixer and mixed at 50 rpm. The rubber was mixed until a temperature of 200° F. (93° C.) was achieved and then held at temperature for a total mixing time of 170 seconds. The rubber was further mixed at less than 75 rpm until a temperature of 212° F. (100° C.) was reached. The rubber was mixed for a total of between 210 and 215 seconds.

### Productive Mixing Step

After mixing, the Masterbatch 4 composition was discharged from the mixing chamber and milled on a two-roll mill set at a temperature of approximately 140° F. (60° C.), to form a sheet, and then allowed cool to ambient temperature. The milled rubber was designated as FM, which is the productive mixing step. Part of the sheet was used to measure the uncured properties, such as Mooney viscosity and Mooney scorch.

Part of the sheet was cured. The curing condition was 160° C. for 15 minutes. The cured sheet was used to measure the cured properties of the rubber composition.

### Air Analysis

Air collection was performed during the mixing step when Silylated Melamine-Formaldehyde Resin was added. In Examples 1,2,3 and 5, the air was collected during the first mixing pass. In Example 3, air was collected during the second mixing pass. After air collection during mixing, the sample tubes were eluted with acetonitrile according to manufacturer's protocol and tested for formaldehyde against a series of standard solutions with known concentrations of formaldehyde using HPLC.

Table 1 lists the formulation for the first and second pass mixing. Table 2 lists the quantified formaldehyde results. For examples 1, 2, 4, 5, the second pass ingredients are not listed because this set of experiments was performed solely for the purpose of air collection in the relevant mixing pass, not for testing physical and dynamic properties of the material. After the air was collected, the mixing was discontinued. The results of Examples 7-10 include the full formulation for physical and dynamic properties of the formed material.

TABLE 1

| | | | | Ex. 4 | Ex. 5 |
|---|---|---|---|---|---|
| | | | | Method | Method |
| | | | Ex. 3 | 1B with | 1B with |
| | | Ex. 2 | Method | formaldehyde | formaldehyde |
| | | Method | 1A | scavenger | scavenger |
| | Ex. 1 | 1B | APTES in | Both Silylated | Both Silylated |
| | Comparative | Silylated | First mixing | Melamine- | Melamine- |
| | Control | Melamine- | pass, Silylated | Formaldehyde | Formaldehyde |
| | Silylated | Formaldehyde | Melamine- | Resin and | Resin and |
| | Melamine- | Resin and | Formaldehyde | APTES in | APTES in |
| | Formaldehyde | APTES in | Resin in | First Mixing | First Mixing |
| | Resin in First | First Mixing | Second | Pass, Sodium | Pass, Sodium |
| Ingredients | Mixing Pass | Pass | Mixing Pass | Sulfite 3 phr | Sulfite 6 phr |
| First Mixing Pass | | | | | |
| Buna CB 24 | 20 | 20 | 20 | 20 | 20 |
| SAN-10/TSR-10 | 80 | 80 | 80 | 80 | 80 |
| Zeosil 1165MP | 50 | 50 | 50 | 50 | 50 |
| N110 | 5 | 5 | 5 | 5 | 5 |
| Process Oil | 1 | 1 | 1 | 1 | 1 |
| (TDAE) | | | | | |
| ZNO | 1.5 | 1.5 | 1.5 | 1.5 | 1.5 |
| Silylated | 6 | 6 | | 6 | 6 |
| Melamine- | | | | | |
| Formaldehyde | | | | | |
| Resin Ref | | | | | |
| APTES | | 2 | 2 | 2 | 2 |
| Sodium Sulfite | | | | 3 | 6 |
| (HCHO | | | | | |
| Scavenger) | | | | | |
| Subsequent | | | | | |
| Mixing Pass | | | | | |
| N110 | | | 5 | | |
| 6PPD | | | 2 | | |
| TMQ | | | 0.5 | | |
| MC wax | | | 1.3 | | |
| ZNO | | | 1.5 | | |
| Stearic Acid | | | 1 | | |
| Silylated | | | 6 | | |
| Melamine- | | | | | |
| Formaldehyde | | | | | |
| Resin Ref | | | | | |

NR = Natural Rubber
TSR = Technically Specified Rubber
SIR = Standard Indonesian Rubber
SAN = a manufacture of NR, TSR and SIR
N110 = high surface area tire tread grade of reinforcing carbon black
Buna CB 24 = Rubbery Polymer
TDAE = triple distilled aromatic extract, a tire tread grade of process oil used as a plasticizer and Tg modifier.
6PPD = N-(1,3-dimethylbutyl)-N′-phenyl-p-phenylenediamine (antioxidant, antiozonant chemical additive)
TMQ = 2,2,4-trimethyl-1,2-dihydroquinoline polymer (antioxidant chemical additive)
MC wax = microcrystalline wax
ZNO = zinc oxide (ZnO)
Zeosil 1165MP = Silica

TABLE 2

| | | | | Ex. 4 | Ex. 5 |
|---|---|---|---|---|---|
| | | | | Method | Method |
| | | | Ex. 3 | 1B with | 1B with |
| | | | Method 1A | scavenger | scavenger |
| | Comparative | Ex. 2 | APTES in | Both Silylated | Both Silylated |
| | Ex. 1 | Method 1B | First mixing | Melamine- | Melamine- |
| | Comparative | Silylated | pass, Silylated | Formaldehyde | Formaldehyde |
| | Silylated | Melamine- | Melamine- | Resin and | Resin and |
| | Melamine- | Formaldehyde | Formaldehyde | APTES in | APTES in |
| | Formaldehyde | Resin and | Resin in | First Mixing | First Mixing |
| | Resin in First | APTES in First | Second | Pass, Sodium | Pass, Sodium |
| | Mixing Pass | Mixing Pass | Mixing Pass | Sulfite 3 phr | Sulfite 6 phr |
| HCHO | 556 | 296.4 | 8.4 | 14.66 | 43.62 |
| collected (ug) | | | | | |

As can be seen in Table 2, formaldehyde was reduced significantly in all examples of the invention (Examples 2-5), compared to the control (Example 1). It can also be seen that the addition of an alkoxymethylamino-functional silane (Silylated Melamine Formaldehyde Resin) to the second mixing pass had a significant further reduction in formaldehyde emission.

### Rubber Properties of Formaldehyde Reduction Method 1

The following data (Table 3) demonstrate that the exemplary rubber properties are maintained, or even improved, when performing formaldehyde reduction Method 1. The compounds containing the aminosilane (APTES) (Ex. 7-10) had equal or greater indicators of compound reinforcement (300% Modulus, Shore A Hardness), abrasion (DIN), and tear strength (Graves Tear, HSTE). They also exhibited improved rolling resistance indicators and dynamic hysteretic response (Rebound @ 70° C., Metravib Temperature sweep tan d@60° C.).

TABLE 3

| | | | | Ex. 9 Method | Ex. 10 Method |
|---|---|---|---|---|---|
| | | | | 1B with | 1B with |
| | | | Ex. 8 | formaldehyde | formaldehyde |
| | | Ex. 7 | Method | scavenger | Scavenger |
| | | Method | 1A | Both | Both |
| | | 1B | APTES in | Silylated | Silylated |
| | Comparative | Silylated | First Mixing | Melamine- | Melamine- |
| | Ex. 6 Control | Melamine- | Pass, Silylated | Formaldehyde | Formaldehyde |
| | Silylated | Formaldehyde | Melamine- | Resin and | Resin and |
| | Melamine- | Resin and | Formaldehyde | APTES in | APTES in |
| | Formaldehyde | APTES in | Resin in | First Mixing | First Mixing |
| | Resin in first | First Mixing | Second | Pass, 3 phr | Pass, 6 phr |
| Ingredients | mixing pass | Pass | Mixing Pass | scavenger | scavenger |
| NP1 | | | | | |
| Kibipol HBR PR-040G | 20 | 20 | 20 | 20 | 20 |
| SAN-10/TSR-10 | 80 | 80 | 80 | 80 | 80 |
| Zeosil 1165MP | 50 | 50 | 50 | 50 | 50 |
| N110 | 5 | 5 | 5 | 5 | 5 |
| Process Oil (TDAE) | 1 | 1 | 1 | 1 | 1 |
| ZNO | 1.5 | 1.5 | 1.5 | 1.5 | 1.5 |
| Stearic Acid | 1 | 1 | 1 | 1 | 1 |
| Silylated Melamine | 6 | 6 | | 6 | 6 |
| Formaldehyde Resin | | | | | |
| Ref | | | | | |
| A1100 | | 2 | 2 | 2 | 2 |
| Sodium Sulfite | | | | 3 | 6 |
| (Scavenger) | | | | | |
| NP2 | | | | | |
| N110 | 5 | 5 | 5 | 5 | 5 |
| 6PPD | 2 | 2 | 2 | 2 | 2 |
| TMQ | 0.5 | 0.5 | 0.5 | 0.5 | 0.5 |
| MC wax | 1.3 | 1.3 | 1.3 | 1.3 | 1.3 |
| ZNO | 1.5 | 1.5 | 1.5 | 1.5 | 1.5 |
| Stearic Acid | 1 | 1 | 1 | 1 | 1 |
| Silylated Melamine | | | 6 | | |
| Formaldehyde Resin | | | | | |
| Ref | | | | | |
| APTES | | | | | |
| NP3 | | | | | |
| Penacolite Resin B-19-S | 1 | 1 | 1 | 1 | 1 |
| Final Mix | | | | | |
| Sulfur | 1.6 | 1.6 | 1.6 | 1.6 | 1.6 |
| CBS | 2 | 2 | 2 | 2 | 2 |
| DPG | 0.4 | 0.4 | 0.4 | 0.4 | 0.4 |
| HMMM (Resimene | 1.25 | 1.25 | 1.25 | 1.25 | 1.25 |
| 3520) | | | | | |

| | | Comparative | | | | |
|---|---|---|---|---|---|---|
| Processing Properties | Units | Ex. 6 | Ex. 7 | Ex. 8 | Ex. 9 | Ex. 10 |
| Mixing Equivalents | MEq | 8.93 | 8.63 | 8.71 | 9.04 | 8.81 |
| Mooney Viscosity | | | | | | |
| MB1 CMS1 + 4(100° C.) | MU | 207.2 | 205.4 | — | — | 202.5 |
| MB2 CMS1 + 4(100° C.) | MU | 105.7 | 103.3 | 99.5 | 105.7 | 103 |
| MB3 CMS1 + 4(100° C.) | MU | 102.8 | 94.9 | 83.5 | 97.4 | 98.3 |
| FM CML1 + 4(100° C.) | MU | 77.3 | 76.2 | 69.6 | 79.8 | 79.5 |
| Mooney Scorch @ 135° C. | | | | | | |
| Small Rotor 3 pt rise | min | 13.02 | 8.84 | 10.07 | 8.78 | 8.94 |
| Small Rotor 10 pt rise | min | 16.67 | 11 | 11.94 | 11.16 | 11.3 |
| MDR (Moving Die Rheometer) | | | | | | |
| @ 160° C., 30 Min. | | | | | | |
| MIN Torque | dNm | 2.88 | 2.91 | 2.53 | 3.09 | 3.04 |
| MAX Torque | dNm | 19.2 | 22.36 | 19.09 | 22.73 | 22.37 |
| Δ Torque | dNm | 16.32 | 19.45 | 16.56 | 19.64 | 19.33 |
| T10 | min | 2.18 | 1.62 | 1.78 | 1.61 | 1.65 |
| T40 | min | 3.51 | 2.43 | 2.55 | 2.45 | 2.44 |
| T90 | min | 5.11 | 3.74 | 3.94 | 3.75 | 3.73 |
| T95 | min | 5.78 | 4.37 | 4.58 | 4.37 | 4.35 |
| Physical Properties | | | | | | |
| Specific Gravity | g/cm3 | 1.153 | 1.157 | 1.155 | 1.167 | 1.179 |
| 50% Modulus | MPa | 1.26 | 1.41 | 1.23 | 1.39 | 1.36 |
| 100% Modulus | MPa | 2.12 | 2.44 | 2.06 | 2.37 | 2.3 |
| 200% Modulus | MPa | 6.05 | 6.92 | 5.99 | 6.74 | 6.54 |
| 300% Modulus | MPa | 11.84 | 13.09 | 12.15 | 12.89 | 12.56 |
| RI (Reinforcement Index, | | 5.6 | 5.4 | 5.9 | 5.4 | 5.5 |
| M300/M100) | | | | | | |
| mod 300 − mod 100 | MPa | 9.72 | 10.65 | 10.09 | 10.52 | 10.26 |
| n = mod 300 | | 5 | 5 | 5 | 5 | 5 |
| Tensile | MPa | 23.7 | 23.2 | 23.7 | 22 | 19.9 |
| Elongation | % | 544.7 | 504.7 | 523 | 486.9 | 458 |
| Break Energy | J | 182.09 | 165.84 | 169.5 | 150.55 | 126.59 |
| Work-to-Break | J/cm3 | 49.73 | 45.52 | 46.41 | 41.2 | 34.6 |
| Shore A @ 25° C. | Shore A | 63.7 | 66.2 | 62 | 64.7 | 64.2 |
| Shore A @ 70° C. | Shore A | 59.4 | 62.5 | 59.2 | 61.9 | 61.1 |
| Graves Tear @ 25° C. (CubeOne) | kN/m | 104.97 | 87.53 | 80.48 | 77.54 | 65.67 |
| Graves Tear @ 100° C. (T2000) | N/mm | 61.3 | 61.9 | 67.3 | 63.3 | 62.1 |
| DeMattia (Pierced) | KC | 2000+ | 2000+ | 2000+ | 256 | 2000 |
| HSTE (High Speed Tear Energy) | MJ/m3 | 8.38 | 7.6 | 7.28 | 7.28 | 7.84 |
| DIN Abrasion | mm3 | 76.5 | 80.4 | 74.6 | 79.1 | 83.3 |
| Dynamic Properties | | | | | | |
| Rebound | | | | | | |
| 25° C. | % | 48 | 48.3 | 51 | 48.5 | 49.1 |
| 70° C. | % | 57.1 | 59.5 | 60.2 | 59.5 | 59.9 |
| 100° C. | % | 61 | 62.4 | 65.8 | 63.9 | 63.2 |
| RPA 2000 - Strain Sweep @ 60° C. | | | | | | |
| G′ @ 2% | MPa | 2.8063 | 2.988 | 1.865 | 2.9461 | 2.8862 |
| G′ @ 5% | MPa | 2.1429 | 2.3219 | 1.5991 | 2.3097 | 2.2678 |
| G′ @ 10% | MPa | 1.6188 | 1.7734 | 1.333 | 1.7761 | 1.7578 |
| Tan δ @ 2% | | 0.156 | 0.156 | 0.128 | 0.155 | 0.151 |
| Tan δ @ 5% | | 0.176 | 0.178 | 0.145 | 0.173 | 0.174 |
| Tan δ @ 10% | | 0.201 | 0.204 | 0.173 | 0.2 | 0.2 |
| Metravib - Strain Sweep | | | | | | |
| G′ @ 0.1% | MPa | 3.8 | 4.9 | 3.1 | 5.2 | 5.3 |
| G′ @ 10% | MPa | 1.9 | 2.2 | 1.8 | 2.4 | 2.4 |
| Δ G′ (Payne Effect) | MPa | 1.9 | 2.7 | 1.3 | 2.8 | 2.9 |
| Tan δ max | | 0.155 | 0.160 | 0.126 | 0.149 | 0.151 |
| Metravib - Temperature Sweep | | | | | | |
| Tan δ @ 60° C. | | 0.096 | 0.086 | 0.077 | 0.082 | 0.085 |
| Tan δ @ Tg | | 0.790665 | 0.726872 | 0.862451 | 0.795383 | 0.777146 |
| Tan δ @ 0° C. | | 0.135177 | 0.125637 | 0.130876 | 0.124083 | 0.123198 |
| T @ Tg | ° C. | 101.108 | 101.061 | 101.119 | 101.069 | 101.101 |

Example 8 (Table 3 cont.) demonstrates several surprising and beneficial results. The evidenced synergy of compounding an aminosilane (APTES) before the alkoxymethylamino-functional silane (Silylated Melamine Formaldehyde Resin) is clear in not just mitigating formaldehyde formation, but also in improving important tire rubber processing and tire performance indicators. Introduction of aminosilanes (APTES) in the first mixing step resulted in the lowest formaldehyde emission of 8.4 μg. It also showed the best balance of green rubber processing indicators with a FM Mooney Viscosity of 69.6 MU and a Mooney Scorch 3 point rise of 10 minutes. The chemistry of APTES typically negatively impacts Mooney Scorch, when compounded in a vulcanized rubber compound with 3 point rise less than 1 minute, which can make the curing of the rubber unmanageable in the context of tire building.

The rubber compound of Example 9 had the best tread wear indicators in reinforcing index (RI) of 5.9 and DIN abrasion at 74.6 mg rubber lost. Finally, this example showed the best tire rolling resistance indicators from the Metravib Strain sweep with the lowest Payne effect and max tan δ of 1.3 and 0.126, respectively, and the lowest tan δ at 60° C. at 0.077 from the Metravib Temperature sweep. When considering all other properties, the benefits of the invention are clear with any other differences easily accounted for with minor formulation adjustments known to those skilled in the art. This results in example 8 demonstrating a particularly preferred mode of the invention, with a major reduction in formaldehyde emission and potential for best-in-class truck tread rubber wear, rolling resistance, and processability.

### Rubber Properties of Formaldehyde Reduction Method 2

Silica pretreated with Silylated Melamine Formaldehyde Resin was prepared and used in rubber compounding to provide acceptable rubber properties with low formaldehyde emission. Formulation details are presented in Table 4. Rubber properties and VOC values are presented in Table 5

### Example 12—AMAFS Pretreated Silica

757 g of Precipitated Silica (Solvay 1165M) was combined with 93 g of AMAFS and 1106 g ethanol. The mixture was agitated until evenly dispersed. The container was then rolled on a roll mill for 4 hours to ensure even dispersion. Subsequently, the silica mixture was dried in a vacuum oven in smaller batches at 55-70° C., and at vacuum levels ranging from 400 to 100 mmHg until the silica reached a stable dry weight. 767 g of AMAFS-treated silica was obtained.

TABLE 4

| | | AMAFS |
|---|---|---|
| | | pretreated |
| | | Silica |
| | | Formulation |
| 0.73/0.705/0.69/0.68 | Comparative | with |
| Ingredients | Example 11 | Example 12 |
| BUNA CB 24 | 20.0 | 20.0 |
| SAN-10/TSR-10 | 80.0 | 80.0 |
| Zeosil 1165MP | 50.0 | |
| 12% AMAFS on silica | | 50.0 |
| N110 | 5.0 | 5.0 |
| Process Oil (TDAE) | 1.0 | 1.0 |
| ZNO AZO-66T | 1.5 | 1.5 |
| Stearic Acid | 1.0 | 1.0 |
| AMAFS | 6.0 | |
| NP1 Total | 164.5 | 158.5 |
| N110 | 5.0 | 5.0 |
| 6PPD | 2.0 | 2.0 |
| TMQ | 0.5 | 0.5 |
| MC wax | 1.3 | 1.3 |
| ZNO AZO-66T | 1.5 | 1.5 |
| Stearic Acid | 1.0 | 1.0 |
| AMAFS | | |
| NP2 Total | 175.8 | 169.8 |
| — | | |
| Penacolite Resin B-19-SC | 0.8 | 0.8 |
| NP3 Total | 176.6 | 170.6 |
| — | | |
| Sulfur | 1.600 | 1.600 |
| CBS | 2.000 | 2.000 |
| DPG | 0.400 | 0.400 |
| Resimene 3520 (HMMM REF) | 1.250 | 1.250 |
| FM Total | 181.9 | 175.9 |

Results:
Comparative Example 11 formaldehyde level: 218.2 ug
Example 12 formaldehyde level: 108.1 ug

The following examples present Methods 1 and 2 combined: (a) Using aminosilane pretreated silica with liquid Silylated Melamine Formaldehyde Resin (b) Using Silylated Melamine Formadehyde and aminosilane pretreated silica and. Table 6 presents the formulations for Examples 13 and 14.

### Example 13: Preparation of APTES Pretreated Silica

759 g of Precipitated Silica (Solvay 1165M) was combined with 32 g of APTES and 1153 g ethanol. The mixture was agitated until evenly dispersed. The container was then rolled on a roll mill for 6 hours to ensure even dispersion. Subsequently, the silica mixture was dried in a vacuum oven in smaller batches at 55-70° C., and at vacuum levels ranging from 400 to 100 mmHg until the silica reached a stable dry weight. 749 g of APTES-treated silica was obtained.

### Example 14: Preparation of APTES and Silylated Melamine Resin Pretreated Silica

770 g of Precipitated Silica (Solvay 1165M) was combined with 33 g of APTES, 93 g of AMAFS and 1154 g ethanol. The mixture was agitated until evenly dispersed. The container was then rolled on a roll mill for 4 hours to ensure even dispersion. Subsequently, the silica mixture was dried in a vacuum oven in smaller batches at 55-70° C., and at vacuum levels ranging from 400 to 100 mmHg until the silica reached a stable dry weight. 815 g of APTES-AMAFS treated silica was obtained.

| | | | APTES and |
|---|---|---|---|
| | | APTES | AMAFS |
| | | pretreated | pretreated |
| 0.73/0.705/0.69/0.68 | Comparative | silica | silica |
| Ingredients | Example 11 | Example 13 | Example 14 |
| BUNA CB 24 | 20.0 | 20.0 | 20.0 |
| SAN-10/TSR-10 | 80.0 | 80.0 | 80.0 |
| Zeosil 1165MP | 50.0 | | |
| 4% APTES on silica | | 50.0 | |
| 4% APTES and 12% AMAFS on silica | | | 50.0 |
| N110 | 5.0 | 5.0 | 5.0 |
| Process Oil (TDAE) | 1.0 | 1.0 | 1.0 |
| ZNO AZO-66T | 1.5 | 1.5 | 1.5 |
| Stearic Acid | 1.0 | 1.0 | 1.0 |
| AMAFS | 6.0 | 6.0 | |
| NP1 Total | 164.5 | 164.5 | 158.5 |
| — | | | |
| N110 | 5.0 | 5.0 | 5.0 |
| 6PPD | 2.0 | 2.0 | 2.0 |
| TMQ | 0.5 | 0.5 | 0.5 |
| MC wax | 1.3 | 1.3 | 1.3 |
| ZNO AZO-66T | 1.5 | 1.5 | 1.5 |
| Stearic Acid | 1.0 | 1.0 | 1.0 |
| AMAFS | | | |
| NP2 Total | 175.8 | 175.8 | 169.8 |
| Penacolite Resin B-19-SC | 0.8 | 0.8 | 0.8 |
| NP3 Total | 176.6 | 176.6 | 170.6 |
| — | | | |
| Sulfur | 1.600 | 1.600 | 1.600 |
| CBS | 2.000 | 2.000 | 2.000 |
| DPG | 0.400 | 0.400 | 0.400 |
| Resimene 3520 (HMMM REF) | 1.250 | 1.250 | 1.250 |
| FM Total | 181.9 | 181.9 | 175.9 |

Comparative Example 11 formaldehyde level: 218.2 ug
Example 13 Formaldehyde Level: <1 ug
Example 14 Formaldehyde Level: 4.33 ug

While the invention has been described with reference to particular embodiments, those skilled in the art will understand that various changes may be made, and equivalents may be substituted for elements thereof without departing from the scope of the invention. It is intended that the invention not be limited to the particular embodiments disclosed, but that it includes all embodiments falling within the scope of the appended claims.

What is claimed is:

1. A silica-based rubber additive for reducing formaldehyde emission during rubber manufacturing, comprising;
a silica-based filler;
at least one hydrolyzable alkoxymethylamino-functional silane (AMAFS) that is reactive with the silica based filler; and
optionally, an aminosilane;
with the proviso that when the aminosilane is not included, the silica-based filler is pretreated with the AMAFS prior to inclusion in the rubber manufacture.

2. The silica-based rubber additive of claim 1, wherein the silica filler is treated with the aminosilane.

3. A method of manufacturing a silica-based rubber additive, comprising:
contacting a silica-based filler with:
(i) a hydrolysable alkoxymethylamino-functional silane (AMAFS) that is reactive with the silica-based filler, and which upon contact with the filler, produces formaldehyde; or
(ii) an aminosilane.

4. The method of claim 3, wherein step (ii) is performed.

5. The method of claim 3, wherein step (i) is performed and step (ii) is performed before or concurrent with step (i).

6. The method of claim 3, wherein when the silica-based filler is contacted with the AMAFS in step (i), the method further comprises (iii) removing the formaldehyde produced during the contact of the silica-based filler with the AMAFS.

7. The method of claim 3, wherein the silica-based filler is silica powder.

8. The method of claim 3, wherein step (i) is performed.

9. The method of claim 3, wherein the AMAFS comprises at least one hydrolyzable silyl group and at least one alkoxymethylamino-functional group, preferably Silylated Melamine Formaldehyde Resin.

10. The method of claim 3, wherein the silica-based filler is functionalized with the aminosilane.

11. The method of claim 3, wherein the aminosilane is aminopropyltriethoxysilane (APTES).

12. The method of claim 3, wherein the silica-based filler is functionalized with both the AMAFS and the aminosilane.

13. A silica-based rubber manufacturing additive made by the method of claim 3.

14. A rubber composition having reduced formaldehyde emission, comprising:
(a) a rubbery polymer or blend of polymers;
(b) at least one hydrolyzable alkoxymethylamino-functional silane;
(c) at least one silica-based reinforcing filler that is reactive with the hydrolyzable alkoxymethylamino-functional silane;
(d) at least one organic resin;
(e) optionally, at least one aminosilane;
(f) optionally, at least one active hydrogen containing organic compound; and
(g) optionally, at least one a sulfur-donating compound;
wherein the silica-based filler is (i) pretreated with the at least one hydrolyzable alkoxymethylamino-functional silane or (ii) the composition includes the at least one aminosilane introduced before or concurrently with the at least one hydrolyzable alkoxymethylamino-functional silane.

15. The rubber composition of claim 14, wherein during manufacture of the rubber composition the amount of formaldehyde produced is reduced by at least 40% compared to the same composition without (i) or (ii).

16. The rubber composition of claim 15, wherein the reduction of formaldehyde produced is at least 80%.

17. A method of forming a rubber manufacturing composition having reduced formaldehyde emission, comprising:
forming a rubbery mix by combining in a first rubber mixing step, a rubbery polymer or blend of polymers and a silica-based filler; and
performing at least one rubber processing formaldehyde emission reducing step, selected from the group consisting of:
(i) pre-treating the silica-based filler with an AMAFS and withdrawing formaldehyde generated during the functionalizing step from the silica-based filler prior to the first rubber mixing step;
(ii) pre-treating the silica-based filler with an aminosilane prior to the first rubber mixing step and (a) functionalizing the silica-based filler with an AMAFS prior to the first rubber mixing step and/or (b) adding the AMAFS to the rubbery mix; and
(iii) adding a formaldehyde reducing amount of an aminosilane to the first rubber mixing step or a rubber mixing step subsequent to the first rubber mixing step and adding an AMAFS or a hydrolyzable alkoxymethylamino resin to the first or subsequent rubber mixing step, with the proviso that the addition of the aminosilane is before or concurrent with the inclusion of the AMAFS or hydrolyzable alkoxymethylamino resin.

18. The method of claim 17, wherein step (i) is performed and the silica-based filler is functionalized with the AMAFS.

19. The method of claim 17, wherein the AMAFS is Silylated Melamine Formaldehyde Resin.

20. The method of any of claim 17, wherein step (ii) is performed, the silica-based filler is pre-treated and functionalized with the aminosilane and (a) the silica-based filler is functionalized with the AMAFS.

21. The method of claim 17, wherein step (ii) is performed, the silica-based filler is pretreated and functionalized with the aminosilane and (b) the AMAFS is added to the rubbery mix.

22. The method of claim 20, wherein the aminosilane is APTES.

23. The method of claim 17, wherein both steps (i) and (ii) are performed, the silica-based filler is functionalized with both the aminosilane and the AMAFS, and the AMAFS is added to the rubbery mix.

24. The method of claim 23, wherein the aminosilane is APTES and the AMAFS is Silylated Melamine Formaldehyde Resin.

25. The method of claim 17, wherein step (iii) is performed and the aminosilane is added in the first mixing step or subsequent to the first mixing step.

26. The method of claim 25, wherein the aminosilane is APTES.

27. The method of claim 25, wherein Silylated Melamine Formaldehyde Resin is included.

28. The method of claim 25, wherein Melamine Formaldehyde Resin is included.

29. The method of claim 17, wherein steps (i) and (iii) are performed, the silica-based filler is functionalized with the AMAFS and then the aminosilane is added to the rubbery mix in the first or a subsequent mixing step.

30. The method of claim 29, wherein the aminosilane is APTES and the AMAFS is Silylated Melamine Formaldehyde Resin.

31. The method of claim 17, wherein step (iii) is performed, the aminosilane is included in the first mixing step and the AMAFS is included in the first mixing step or a subsequent mixing step.

32. The method of claim 17, wherein step (iii) is performed, the aminosilane is included in the first mixing step and the AMAFS is included in the first mixing step.

33. The method of claim 31, wherein the silica-based filler is pre-treated with an AFAFS.

34. The method of claim 17, wherein the aminosilane has Formula (AS). 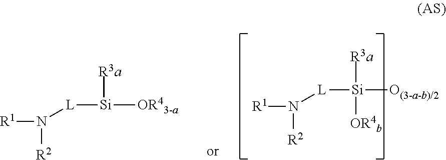
wherein:
L=C1-C10 straight or branched alkylene group or C5-C14 cycloalkylene group
R¹═H, C1-C10 straight or branched alkyl or alkylene group which may contain hetero atoms such as N or O, C5-C14 cycloalkyl group which may contain hetero atoms such as N or O, C5-C18 aryl or aralkyl group which may contain hetero atoms such as N or O,
R²═R¹ or -L-Si(R3) (OR4)3-a
R³═C1-C10 straight or branched alkyl or alkylene group, C6-C18 aryl or aralkyl group
R⁴═H, C1-C10 straight or branched alkyl or alkylene group, C6-C18 aryl or aralkyl group
$$a = 0 , 1 , 2$$
$$b = 0 , 1 , 2$$
$$a + b \leq 2$$

35. The method of claim 17, wherein the aminosilane is selected from the group consisting of: gamma-aminopropyltrimethoxysilane, N-beta-(aminoethyl)-gamma-aminopropyltrimethoxysilane, N-(2-aminoethyl)-N′-[3-(trimethoxysilyl) propyl]-1,2-ethanediamine, gamma-aminopropyltriethoxysilane, aminopropylsilsesquioxanes, bis-(gamma-triethoxysilylpropyl)amine, bis-(gamma-trimethoxysilylpropyl)amine, N-beta-(aminoethyl)-gamma-aminopropylmethyldimethoxysilane, N-ethyl-3-trimethoxysilyl-methylpropamine, 4-amino-3,3-dimethylbutyltrimethoxysilane, and N-[3-(trimethoxysilyl) propyl]-benzenamine.

36. The method of any of claim 17, wherein the AMAFS comprises at least one hydrolyzable silyl group and at least one alkoxymethylamino-functional group.

37. The method of any of claim 17, wherein the rubbery mix comprises a formaldehyde scavenger.

38. The method of claim 37, wherein the formaldehyde scavenger is sodium sulfite.

39. The method of claim 17, wherein the formaldehyde emission reduction step is effective to reduce the amount of formaldehyde produced without said step by at least 40%.

40. The method of claim 17, wherein the formaldehyde emission reduction step is effective to reduce the amount of formaldehyde produced without said step by at least 80%.

41. The method of claim 17, wherein the formaldehyde emission reduction step is effective to reduce the amount of formaldehyde produced without said step by at least 95%.

42. A cured rubber composition formed by the method of claim 17, wherein the primary polymeric network is crosslinked.

43. An article comprising the cured rubber composition of claim 42.

44. The article of claim 43, wherein the article is at least a component of a tire.
